(19) United States
(12) Patent Application Publication
(10) Pub. No.: US 2026/0198472 A1
(43) Pub. Date: Jul. 16, 2026

(54) METHOD OF ATTACHING A HOOF PROTECTOR TO A HOOF OF AN EQUINE ANIMAL

(71) Applicant: Toni Quint, Bad Teinach-Zavelstein (DE)

(72) Inventors: Ines WERNER, Karlsruhe (DE); Ralph SUIKAT, Ettlingen-Ettlingenweier (DE)

(21) Appl. No.: 19/559,035

(22) Filed: Mar. 6, 2026

Related U.S. Application Data
(62) Division of application No. 18/290,571, filed on May 16, 2022.

(30) Foreign Application Priority Data
May 15, 2021 (LU) 102801

(51) Int. Cl. A01L 5/00; A01L 3/00

(52) U.S. Cl. CPC A01L 5/00; A01L 3/00

(57) ABSTRACT

The present invention related to a method of thermally welding a thermoplastic hoof protector lug system to an equine hoof wall is disclosed. The method includes partially melting a hoof-facing layer of at least one lug of a collar-based lug system having lugs connected to the collar by webs around at least one elliptical or superelliptical recess, bringing the partially melted layer into contact with the hoof wall, and forming a material-bonded connection by cooling.

### TECHNICAL AREA

The present invention relates to a hoof protector for equidae (e.g. horses, donkeys) as a combination product, comprising at least one hoof protector sole and a hoof protector lug system, for attachment to a hoof of the equidae in particular for therapeutic purposes, and to the method of attaching the same without the need for nailing to the hoof, and to the method of manufacturing the combination product by means of thermoplastic master molding methods, in particular by means of injection molding methods.

### STATE OF THE ART

Equidae, in particular horses, have been used for thousands of years as farm animals for pulling or carrying loads or for (their own) locomotion. The applications of the invention described below relate not only to horses, but also to other equines (e.g. donkeys), which are also meant herein.

The equids are mammals of the order of the odd-toed ungulates, which represent the family of horses, especially horses as solipeds. A hoof of an equid and/or horse is used as a synonym for the anatomical name of the hoof capsule. The equine hoof capsule consists of the hoof wall, which encloses the hoof laterally, the hard sole, which closes to the ground, and the hoof ray, the soft part of the hoof sole. The ground-side edge of the hoof wall, the so-called bearing edge, and the hoof sole are separated by the white horn line, which indicates to the farrier, for example, where he can hammer in nails without damaging the sensitive corium. The upper edge of the hoof capsule is referred to as the horn crown, which merges into the normal hairy skin. The hoof capsule is divided into three areas from front to back. The front area is called the toe, the middle area on the right and left is called the lateral wall and the rear area is referred to as the heel.

With the domestication of horses, they increasingly moved on paved ground (e.g. on asphalt roads). This has the disadvantage that the hooves do not wear against the ground as they would in free nature. Instead, the hooves have to be protected with special devices known as horseshoes. Among other things, these affect the physiology of the gait.

A Gentle gait physiology and/or the most natural hoof mechanism possible is the focus of various professional groups, such as the hoof orthopaedist, the hoof trimmer and the hoof technician, because it contributes significantly to the overall quality of life of horses. The hoof protector product according to the invention is an important working tool for these professional groups and is used in various areas such as equestrian sports, horse breeding and horse health.

Normally, horses only touch the ground with the hoof's hoofed middle toe. When a hoof is loaded by the weight of the horse (and rider), large mechanical forces occur, which increase significantly with loads or high locomotion speeds. An Optimal force transmission is naturally made possible by the physico-mechanical properties of the hoof's horn material and the hoof, tendons and pasterns as a whole. In addition, a balance is achieved in the free nature through constant wear and tear and the continuous reproduction of the hoof material. This equilibrium, caused by varied stress and regeneration and rest phases of the horse, generally requires no intervention, to ensure optimum hoof care.

The hooves of domesticated horses, on the other hand, which are used more frequently or more unilaterally for commercial or recreational purposes than those of horses living in the wild, must regularly be provided with protection. The hoof protector, hereinafter referred to as the various types of horseshoes, hoof boots, hoof guards and hoof protector devices, are generally a necessity in the context of hoof care for domesticated horses. The application of a hoof protector by the user has a direct influence on gait mechanics and thus on the horse's ability to move.

Only a hoof protector enables domesticated horses to be kept in a species-appropriate and economically efficient manner as livestock, sport and leisure animals or as an investment. In the entire equestrian sports industry, for example equestrian sports or vaulting, optimum hoof protectors are therefore of crucial importance.

An important tool is the optimal hoof protection in the therapy or rehabilitation of horses, especially in high-performance equestrian sports (e.g. show jumping, dressage, military, polo, horse racing). A hoof protector that can be put on for 24 hours a day for several weeks or months has proven to be particularly effective for therapeutic purposes and has developed into a high-selling product niche in its own right. The demand for optimal hoof protection is not limited to therapy, however, veterinarians, horse breeders, farriers and hoof trimmers are equally dependent on the development of a commercially available hoof protector.

As varied as the possible uses of the horse are, so are the demands on an optimal hoof protector. In general, the trend in modern horse husbandry is clearly moving towards the naturality of the hoof protector, so-called bare hoof walking, so that conventional metal “horseshoes”, which are nailed to the bottom side of the hoof, can be considered obsolete. Nevertheless, metal hoof protectors, also known as horseshoes, are still the most popular and most frequently used hoof protectors today. The primary purpose of the horseshoe is to reduce abrasion of the hoof when walking on paved ground. Horseshoes are essentially U-shaped and are generally metal parts with nail holes, which are attached directly to the outer edge of the horn part of the hoof by means of nailing, known as shoeing. Horseshoes are made of metal, in particular iron, aluminum or its alloys. Although aluminum-based hoof protectors offer improved shock-absorbing properties, they are significantly inferior to iron-based alloys in terms of material suitability for the application, such as elongation at break, and therefore require unfavorably short intervals between re-shoeing.

The high specific weight of a metal hoof protector is detrimental to the horse's movement and can pose an increased risk of injury to the horse, its conspecifics and humans. Due to its weight, the horseshoe is subject to high centrifugal forces during the horse's gait, especially at higher running speeds such as trotting or especially galloping, which can irreversibly damage the horse's musculoskeletal system. Furthermore, the shock-absorbing effect of the hoof is significantly reduced by the metal shoeing, so that the high-frequency impulses, which are perceptible as the characteristic clacking sound of the horseshoe, can lead to physiological damage in the anatomical structure of the horse's locomotor system, which has a detrimental effect on the entire gait mechanics. In order to counteract the direct transmission of force caused by the hardness of the metal, two-component systems such as damping plastic elements between the horseshoe as a hoof protector and the horse's hoof have not been able to establish themselves.

Another disadvantage of using horseshoes is the impairment of thermal insulation and the hoof's sense of touch. Furthermore, the low sliding friction of metals, especially on hard ground, means an increased risk of injury and falls for the horse and its rider when horseshoes are used. A hoof protector made of metal can slip on asphalt roads and paths, especially in corresponding weather conditions, due to a lack of adhesion.

Conventional horseshoes are increasingly being replaced by hoof protectors made of plastic—due to the high demand in the economically strong horse breeding and high-performance equestrian sports sectors.

Plastic hoof protectors have been commercially available for several years and can be selected from a variety of plastic groups and their composites, which can be selected corresponding to their versatile properties and depending on the field of requirements (e.g. ground, weather). However, the requirement profile of a hoof protector is very complex and is primarily made up of the requirements of gait mechanics (constantly changing loading and unloading due to the weight of the animal, impact and abrasive processes), changing ground conditions (meadow, sand, gravel, stones, paving, asphalt), changing weather conditions (e.g. temperature fluctuations) and chemical conditions (corrosion caused by feces or damp stable flooring). Furthermore, it has been shown that plastic sheets are either too heavy for secure and long-term attachment or that the hoof protector material is not robust enough to meet the requirements of optimal hoof protection.

Plastics that correspond to these material requirements after production of the molded parts are often not sufficiently machinable (cutting, flexing or sawing) to achieve an individual fit for the hoof. Polymeric plastic materials for the use of hoof protectors that allow mechanical post-processing, on the other hand, are usually too soft or so temperature-sensitive that thermal post-treatment leads to uncontrolled deformation (e.g. bulging). Progressive deformation of a polymer hoof protector over the wearing time is already known due to the unidirectional and frequent force effect of the loading and unloading processes corresponding to the horse's movement mechanics, especially in heavy horses. Subsequent deformation of the hoof protector must be avoided in any case, as it can lead to pressure points or orthopaedic damage to the horse.

Through special additives such as plasticizers or fillers, the mechanochemical properties of plastics can be modified to a limited extent, for example to improve traction, in particular the grip on a paved ground.

Alternatively, an integrated hoof protector aims to combine the advantageous properties of metal and plastic for hoof protection. The integrated hoof protector refers to a combination product consisting of metal segments embedded in polymer. Alternatively, products with a metal or carbon core embedded in plastic are known. However, the use of different materials within the hoof protector is usually disadvantageous. The situation referred to below as the multi-component problem describes this intrinsic disadvantage of the incompatibility of individual components with regard to different claims. If several materials, in particular with differing physicochemical properties, are used together in the same molded body, the stability-related suitability of the molded body consisting of several components is limited, for example. More specifically, deviations in physiochemical properties such as stiffness, hardness, abrasion, impact strength and thermal expansion of different components lead to limitations in the quality of an integrated hoof protector. The coefficient of thermal expansion is a material-specific material constant that describes the changes in the dimensions of a molded part when the temperature changes and serves as a measure of heat resistance.

Also, for permanent use, different coefficients of thermal expansion of different materials, for example, during temperature fluctuations of the intended use (seasons, temperature of the stable or pasture), lead to “splintering” or relative displacements of the materials of the hoof protector to each other. Likewise, the varying wear of the materials poses considerable safety risks. For example, it is known that a plastic hoof protector with a metal core leads to faster wear of the plastic and thus to protrusion of the metal core, which can grind off sharp edges and thus pose a high risk of injury to the horse, its conspecifics or the rider.

One approach to integrated hoof protection in an effort to combine different hardnesses in one hoof protector by combining several materials in the same hoof protector is pursued with a flat and flexible midsole between the hoof and the hoof protector. For example, patent specification DE102012100135A1 mentions an intermediate sole made of leather, polymer film or textile fabric in the hoof protector. Furthermore, midsoles in the form of latex layers, which are attached to the space between the hoof and the hoof protector using urethane adhesives, for example, are also known.

Horse boots are non-permanent hoof protectors which, in contrast to the aforementioned hoof protector variants, are generally pulled over the horse's hoof. Although horse boots made of synthetic materials are commercially available in different sizes and/or standardized dimensions, individualized adaptation of the hoof boot is only possible to a limited extent. The use of the hoof boot is limited to horses with hoof sizes close to the standardized dimensions. Corresponding to the hoof enclosing character of hoof boots, moisture or foreign bodies (e.g. stones) as well as dirt can accumulate in the horse boot, which favors damp chafing and microbial infestation up to rotting. Generally speaking, despite the hoof-enclosing nature of hoof boots, their loss-proof and non-invasive attachment to the hoof remains an unsolved technical problem to this day. The sum of the disadvantages described above means that the hoof boot can generally only be used for the duration of the riding period; in any case, it cannot be used for several weeks.

Patent specification DE102006006880B4 describes a hoof boot (comprising a sole and a detachably connected shell-like upper shoe with lateral boundary walls) whose closed design of the sole makes it possible to support the gait over the entire hoof tread surface using a single elastic plastic material, thus demonstrating a solution to the multi-component problem. Patent specification DE202012101920U1 describes an orthopaedic hoof protector made of solid thermoplastic polyurethane (TPU) material. However, the base plate of a hoof protector is herein disadvantageously made of a cross-linked TPU, which severely restricts the flexibility of the sole.

In summary, hoof boots, hoof protectors or shoes made of iron or aluminum and its alloys as well as plastic or its composites have established themselves as unsatisfactory to date. Metals have the insurmountable disadvantages of high weight or insufficient slip resistance. Multi-component systems have not been able to establish themselves satisfactorily even by gaining the advantageous properties of several materials, as the incompatibility of the individual components results in one of the aforementioned disadvantages. The most promising approach for optimal hoof protection is the use of synthetic materials.

Plastic hoof protectors are generally attached to the hoof with either nails or adhesives. The attachment of hoof protectors with nails is invasive; it damages the horse's horn material, makes the horn material unstable and susceptible to microbial colonization and/or decay.

The above-mentioned invention DE102006006880B4 follows the spirit of the embodiment of a non-invasive attachment of a hoof boot to the hoof. However, this approach is attached using a complex construct of plastic screws, hooks, recesses, adjustable clamping means and ratchets. It should be noted that each fastening component contributes to the likelihood of material failure or loss of the hoof protector. Similar complex constructions of hoof boot fixation are known (EP1738641A1, DE202007013629U1). Patent specification U.S. Pat. No. 1,761,241 A describes the attachment of a hoof protector to a hoof by several inwardly oriented teeth and prongs by means of three detachably attached L-shaped fingers, whereby the attachment is similarly disadvantageous due to the number of parts and the time-consuming attachment or removal of the hoof protector to the hoof. Patent specification DE10346480A1 discloses a product for detachably attaching a multi-part hoof protector by means of a hanger which adheres to the hoof, is attached to the hoof protector unit by at least one pulling means and is designed to remain on the hoof. Disadvantageously here is the short wearing time due to the complex fastening construction using clamps, tensioning means and buckles. The use of many components and several different materials (multi-component problem, as discussed above) results in intrinsic mechanical instability, complicated attachment and a restriction of the wearing time of the hoof protector to the material components most susceptible to ageing processes. Similar designs of hoof boot fixation are known (U.S. Pat. No. 6,305,328B1).

Conversely, DE 10 2016 110 657 A1 encompasses a hoof protector, whose base plate is fixed to a hoof by means of a hook-and-loop fastener. This step solves the need for partial and time-consuming application of the hoof protector as well as the multi-component problem, but hook-and-loop fasteners are not advantageous for long-term therapeutic applications or in the dirty and microbially contaminated environment of horse husbandry. In addition, the acoustics when loosening the hook-and-loop fasteners frighten the animals. Both fixation systems for attaching a hoof protector to the hoof, hook-and-loop fastener systems or straps, cause pressure and chafing points on the horses'articulated pasterns and are therefore limited to niche applications, for example therapy of a horse's hoof for a few days.

Hoof protectors are also known that are attached to the outside of the hoof with at least one fastening lug. Lug systems made of tear-resistant elastomer are generally attached to the horse's hoof by gluing them to a wide variety of plastic fittings by bonding the surface of the lug to the surface of the hoof wall. Adhesives, such as one-component adhesive kits, are used to bond lug systems to plastic fittings. In general, adhesive attachment is not satisfactory for the long-term application of attaching a hoof protector to a horse's hoof because it is not loss-proof or reliable. In general, even the strongest adhesive bonds cannot withstand the permanent mechanical and chemical stresses of a hoof protector.

Therefore, a holistic approach to hoof protectors is required that synergistically combines materialistic advantages with regard to the complex requirement profile and elastically meets the mechanical load reduced in this way.

### Task

The present invention is therefore based on the technical task of providing a hoof protector, in particular a therapeutic hoof protector, which enables a permanently stable hold on the hoof and a non-invasive application.

Furthermore, it is the task of the invention to provide a hoof protector and a method for attaching it in order to enable quick, simple and gentle shoeing and/or changing of the shoe for the horse.

In addition, the state of the art reveals a need to provide a hoof protector that is lightweight but chemically and mechanically resilient. The hoof protector should therefore be hard and break-resistant, but flexible and shock-absorbing in accordance with hoof physiology, corresponding to the impulse forces of the horse's run.

### SOLUTION

According to the invention, this task is solved by a hoof protector for equidae according to claim 1. Further advantageous embodiments are given in the subclaims.

The hoof protector sole according to the invention for an equine hoof comprises at least one base plate made of a thermoplastic polymer (TP), wherein the TP has a hardness of at least 35 Shore(A), preferably in the range from 50 to 98 Shore(A), more preferably in the range from 65 to 98 Shore(A), most preferably in the range from at least 75 to 98 Shore(A), and the base plate has an upper side and a bottom side, and wherein the bottom side of the base plate substantially reproduces the shape of the ground contact area of the hoof.

### DESCRIPTION AND ADVANTAGES OF THE INVENTION

### Hoof Protector Sole

The invention relates to a hoof protector sole for an equine hoof, comprising at least one base plate formed from a thermoplastic polymer, wherein the base plate has an upper side and a bottom side, wherein the bottom side substantially replicates the shape of the ground contact area of the hoof, wherein the thermoplastic polymer has a hardness of at least 35 Shore, preferably in the range of 50 to 98 Shore, particularly preferably in the range from 65 to 98 Shore, wherein in particular the base plate comprises at least one core and a mantle surrounding the core, wherein the mantle preferably completely surrounds the core, wherein the mantle is preferably formed from a thermoplastic polymer, and wherein the surface of the core comprises core elevations, in particular structured core elevations, and/or core indentations.

In addition to the thermoplastic polymers mentioned herein, the thermoplastic polymer preferably comprises other suitable materials such as rubber, silicones or composites. Further preferably, these further suitable materials can also be meltable by increasing the temperature.

Due to the core elevations and/or the core indentations, it can be advantageously achieved that the connection of the material of the mantle to the core is mechanically more stable. This is particularly advantageous if the core and the mantle are made of different materials.

The core elevations of the core can be structured in such a way that they are essentially parallel to the base plate. Therefore, a better mechanical connection is advantageously provided in the vertical direction (orthogonal to the surface of the base).

A core elevation, in particular a structured core elevation, can also be angled (e.g. in a T-shape), wherein the vertical axis of the T is connected to the core, whereas the horizontal axis of the T is directed outwards, i.e. away from the center of the base plate.

The core elevations can, for example, be spring-structured. For example, the core can be made of a metal, wherein the outwardly extending structured core elevations are quite long. This makes it advantageous to adjust the damping of the hoof protector sole without having to change the hardness of the thermoplastic polymer used, as the choice of a different thermoplastic polymer for other damping properties may mean that the desired properties (e.g. resistance to chemicals) are no longer available.

A combination product refers to the realization of components acting spatially side by side for targeted use in a functional context, which results in a new synergetic technical effect. The hoof protector according to the invention therefore comprises herein a hoof protector sole, a hoof protector lug system and the hoof protector functionally combined from both components as a functional combination product of the individual components for protecting a hoof of an equine and/or a horse.

According to the invention, a hoof protector sole refers to a running or ground contact area of the hoof protector, i.e. its lower part, which is in direct contact with the ground.

It is an object of the invention to provide a hoof protector sole for a hoof of an equine and/or a horse, which is essentially formed from a base plate made of a thermoplastic polymer (TP).

### Thermoplasticity General

As polymers, the basic material of a plastic, macromolecules are referred to, which are made up of a large number of small repeating units, the monomers. The type of monomers, the number of repeating units and the way in which they are linked together significantly determine the physicochemical properties of plastics. An effective modification of the properties of a plastic without changing its basic chemical building blocks and/or altering the composition of the monomers is technically highly significant and possible through chemical cross-linking of the macromolecules. In this way, technically relevant parameters can be modified in an economically advantageous way without the need for a large number of different monomers as base chemicals. The cross-linking, in the sense of an intermolecular ligation of mostly linear macromolecules, leads to a multiplication of the molecular mass of the polymers. Of relevance to materials technology is the significant decrease in the thermo-elastic properties of the cross-linked products with increasing cross-linking until the individual polymers are linked to form a common covalent network. In chemical terms, cross-linked polymers are duroplastic polymers, also referred to as duroplasts, whose intermolecular ligations irreversibly degrade at temperatures above the decomposition temperature T_{z}, so that processing in the melt is not possible. The covalent network of elastic polymers, also referred to as elastomers, is more widely meshed than that of duroplastics, so that the molecular chain movements of linear components enable amorphous behavior and processability, usually covering a temperature range of the ambient temperature.

Thermoplastic polymers (TPs), also referred to as thermoplastics, exhibit no or few intramolecular crosslinking points compared to elastomers, whose linear macromolecules are connected to each other by weak physical bonds. Amorphous TPs are characterized by reversible formability in a discrete temperature range between the glass transition temperature (T_{G}) and T_{z}.

The thermoplastic unique selling point of the thermally induced plasticity of TPs advantageously enables the reversible formability and weldability of molded articles made of TPs, wherein dimensional stability of the molded body is achieved after cooling below TG. In a subgroup of TPs, thermoplastic elastomers (TPEs) are included, which have a thermally reversible formation of cross-linking points. To this group belong, for example, some thermoplastic urethanes (TPUs), in which the thermally reversible cross-linking is formed by non-covalent bonds, for example hydrogen bonds, between the discrete chain segments. The technically relevant properties of TPUs can be modified in many different ways. In this way, the realization of a wide range of application-specific relevant parameters is possible, which is particularly advantageous for the design of the complex requirement profile of a hoof protector.

The reversible formability of TPs is used very advantageously according to the invention for the production of hoof protectors using the primary forming method, one of the most economical manufacturing methods. In primary molding, a solid body of geometrically defined shape is produced from a shapeless material. Primary molding from the plastic state, especially from the polymer melt, is possible using an injection molding method, for example. Injection molding is referred to as a discontinuous method for the production of molded bodies made of plastic by thermochemical shaping, usually from granulated starting material. The injection molding method enables the production of complicated molded parts in large quantities as well as high quality in terms of the shape and dimensional accuracy of the molded bodies produced. The dimensional accuracy is of great importance due to the structure-property correlation of articulated technical molded bodies such as hoof protectors. For example, the exact design determines the dimensional stability of the hoof protector. The production according to the invention of a hoof protector by injection molding is explained in more detail below.

In the non-plastic state, generally at room temperature, the thermoplastic character of TPs also allows for machining post-processing. Machining includes drilling, turning, tapping and threading, sawing, milling, filing, and grinding. In this way, molded bodies manufactured by injection molding can be further altered to individually adapted shapes. This post-processing enables the advantageous adaptation of mass-produced hoof protectors to the individual hoof geometry of an equine. Here, the price advantage of series production can be passed on to the user of a hoof protector without loss of the product's customizability. The processing is possible with standard tools and conventional machine tools. Therefore, no special tools are required for machining a hoof protector; for example, tools suitable for machining steel are sufficient. It has been shown that a high cutting speed at a low feed rate and rapid removal of the chip enables effective removal of a molded body from TP material and thus advantageously enables the individual design of a hoof protector.

In addition, the reversible formability of TPs advantageously enables molded bodies formed by injection molding to be fused together by renewed thermal heating even after the original molding method and to be bonded together in this way. Here, advantageously, additional adhesives, which are usually harmful to health, are not necessary. The thermoplastic joining of modules of a hoof protector is in accordance with the invention and is explained in more detail below.

The thermoplastic base material of a hoof protector according to the invention can generally be selected from any TP, such as thermoplastic esters, ethers, amides and imides. It is important that it is a hard plastic or hard rubber. These include, in particular, those specified in DIN EN ISO 868. As a base material for the hoof protector, in addition to other materials, polyamide (PA), thermoplastic polyethylene (TPE), polyethylene terephthalate (PET), polybutylene terephthalate (PBT), or thermoplastic polyurethane (TPU) are suitable, which have a Shore hardness class A and/or class D as defined herein. These materials have been found to be suitable for use as the base material of both the hoof protector sole, optionally comprising the possible core, as well as for the hoof protector lug system of the hoof protector according to the invention. Particularly preferably, the hoof protector sole, the core of the hoof protector sole and/or the hoof protector lug system consists of the TPs defined herein. The Shore(A) hardness for suitable TPs, in particular for suitable polyamides (PA), thermoplastic polyethylenes (TPE), polyethylene terephthalates (PET), polybutylene terephthalates (PBT) or thermoplastic polyurethanes (TPU), can be found in various (tabular) works, e.g. Arndt and Lechner (Eds.), Advanced Materials and Technologies, Part 3: Mechanical and Thermomechanical Properties of Polymers, Springer-Verlag, Berlin (2014), pp. 357-379 (ISBN 978-3-642-55165-9).

For example, thermoplastic polyethylene (TPE) has a shore hardness A of over 90.

In a preferred embodiment, the TP of the hoof protector sole according to the invention for the hoof of an equine and/or a horse comprises unreinforced thermoplastic polyurethane elastomer (TPU) having a hardness in the range from 50 to 98 Shore, most preferably TPU-57(D), TPU-75(A), TPU-80(A), TPU-86(A), TPU-87(A), TPU-89(A), TPU-90(A), TPU-91(A), TPU-95(A), TPU-96(A) or TPU-53(D), TPU-58(D), TPU-75(D), TPU-80(D) or mixtures thereof. The hoof protector sole is particularly preferably made of one of the aforementioned materials.

The thermoplastic polyurethane elastomers defined herein are particularly suitable for forming the base plate of the hoof protector sole, as they are characterized by high abrasion resistance and high flexibility at the same time.

When choosing the material of the TPs hoof protector, the hardness of the material is of great importance, as this directly determines the mechanical resistance of the hoof protector when an equid steps on it, and also correlates directly with secondary parameters such as shock absorption properties or the stability of the hoof protector.

The Shore hardness is a key figure for the material hardness of TPs. By hardness according to Shore, the resistance of a material to the penetration of a body or a truncated cone under a defined spring force is understood. The key figure can thus be understood as a direct measure of the possible penetration of uneven ground into the hoof protector when used as intended, including the penetration angle and penetration depth relevant in practice.

For the determination of Shore hardness according to Shore A or Shore D, DIN ISO 7619-1 (3 s) specifies concrete requirements for carrying out the measurements and for calibrating the test equipment. This includes that each measurement must be carried out on a test sample with a material thickness of at least 6 mm. There is no general dependency between Shore A and D. Of particular relevance in the context of TPs is the Shore hardness according to class A. The scale of Shore hardness values ranges from 0 Shore (2.5 mm penetration depth, which corresponds to resistance-free penetration of, for example, a truncated cone into the workpiece under investigation) to 100 Shore (corresponding to no penetration). For a hoof protector, the material should offer the penetrating object, for example a pebble, just enough resistance to allow it to penetrate so that no overall impulse is passed on to the hoof, but the pebble should also not penetrate so deeply that it sticks. This means that the Shore hardness requirements for hoof protectors are between that of a car tire (A hardness approx. 50-70 Shore) and that of hard plastic (A hardness approx. 100 Shore). A large number of thermoplastics are therefore less suitable as a material for hoof protectors, preferably injection-molded, as the hardness of polystyrene (PS), polymethyl methacrylate (PMMA), polycarbonate (PC), polyvinyl chloride (PVC), poly(acrylonitrile-co-butadiene-co-styrene) (ABS), PE-HD, polypropylene (PP), poly(oximethylene) (POM), polyamides (PA66, PA610) or glass fiber-reinforced PAs and PPs are generally greater than can be even quantified with this method.

The TP of the base plate of the hoof protector sole has, in the inventive sense, a hardness of at least 35 Shore(A), preferably from 50 to 98 Shore(A), and particularly preferably from 65 to 98 Shore(A), most preferably in the range from at least 75 to 98 Shore(A). By way of example, the abrasion and/or wear resistance of molded bodies generally decreases decisively with the hardness of the sliding partners, wherein this relationship is system-dependent and can correlate with the roughness of the surface of the molded bodies. It has therefore proven to be particularly advantageous if the TP of the hoof protector sole is an unreinforced thermoplastic polyurethane elastomer (TPU) with a hardness in the range of 50 to 98 Shore(A), most preferably 65 to 98 Shore(A), such as e.g. TPU- 57(D), TPU- 75(A), TPU-80(A), TPU-86(A), TPU-87(A), TPU-89(A), TPU-90(A), TPU-91(A), TPU-95(A), TPU-96(A) or TPU-53(D), TPU-58(D), TPU-75(D), TPU-80(D) or mixtures thereof. The thus preferred hardnesses of the thermoplastic polymer of the hoof protector sole are possible, for example, in the use of polyester-based TPU elastomers, with or without glass fiber, glass bead or carbon fiber reinforcement for the hoof protector sole.

In addition to hardness, a low weight of a hoof protector sole is significant for optimal hoof protection, in order to minimize mechanical stress during movement. According to the invention, the hoof protector sole is comprised of a thermoplastic polymer with a density of less than 5 g·cm⁻³, preferably less than 1.5 g·cm⁻³, more preferably less than 1.3 g·cm⁻³.

Other mechanical parameters, such as deformation under mechanical impulses, are important for the properties of a hoof protector. The elastic deformation of a solid body, such as a hoof protector, is expressed by the modulus of elasticity (modulus of elasticity) and is also described as stiffness and/or elasticity.

The modulus of elasticity is determined as the ratio of stress to strain in the tensile test in accordance with DIN EN ISO 527-1A and provides information about the stiffness and/or elasticity of the solid body. Mechanical loads in the application of the hoof protector are simulated in the best possible way in the tensile test, as a stress distribution is kept constant over the entire relevant test specimen length. The TP of the hoof protector sole preferably has a tensile modulus of at least 50 mPa, preferably in the range of 60 to 100 mPa, particularly preferably in the range of 75 to 95 mPa. Since thermoplastic polyurethanes (TPUs) advantageously comprise a very wide modulus of elasticity and outperform polymers such as polyethylene (PE), polyamide (PA), acrylonitrile-butadiene-styrene copolymers (ABS) and in some cases polyvinyl chloride (PVC) in this property, TPUs are preferably used in one embodiment as a base material for a hoof protector, in particular for the embodiment of the base plate.

According to the invention, the hoof protector sole is made of thermoplastic polymer (TP). Since the hoof protector sole according to the invention, in particular its base plate, in a preferred embodiment dispenses with the use of metal, the hoof protector advantageously does not have to be removed when the horse undergoes a radiodiagnostic examination. In equidae with metallic components in the hoof protector, artifacts are produced during radiological diagnostics, in particular during X-rays. Therefore, every decision on radiological diagnostics also means a decision on a change of hoof protection, so that the cost and effort calculation is often to the disadvantage of carrying out a radiological examination and thus to the disadvantage of the animal's recovery. This aspect is of great importance in the therapeutic field or the accident treatment of equids, as the hoof protector can also be applied directly after surgeries while the equid is lying down, either anesthetized or exhausted. With conventional farriery, it is necessary to wait until the equine animal is able to stand before applying the hoof protector, which results in a further stressful treatment step for the already stressed accident animals.

The base plate of the hoof protector sole comprises a top side and a bottom side, wherein the bottom side essentially reproduces the shape of the ground contact area of the hoof in a form-fitting manner when used as intended, wherein the top side is preferably designed as a planar plane which follows the shape of the bottom side in its horizontal boundary.

The thermoplastic base material of a hoof protector, in particular the hoof protector sole, very especially its base plate, can be selected, for example, from one of the following materials: glass fiber-reinforced TPU, polyester-based TPU and/or polyether-based TPU. This has the advantage that the material properties of the hoof protector, in particular the hoof protector sole, especially its base plate can be adjusted in a targeted manner corresponding to the stress.

When using TPU as the base material for the hoof protector, the base material can advantageously generally be recovered from the shoe in a simple recycling step at the end of the hoof protector's life cycle and then reused for a new hoof protector. In a particular embodiment, polyester-based TPU is used as the thermoplastic base material for the hoof protector sole. In the following embodiments, the technical properties of polyester-based TPU-90(A) are exemplified, which are advantageously for the use as base material for the base plate of solid material and/or for the mantle of the hoof protector. The hardness of TPU- 90(A) is approximately 93 Shore(A) and is therefore within the range found advantageously according to the invention of Shore hardnesses of 50-98 Shore(A) for the material of a hoof protector. In addition to the ranges of TG relevant for thermoplasticity and the coefficient of thermal expansion of the TPU, high stiffness, optimum Shore hardness and low abrasion and/or very good wear resistance, high tensile strength and excellent tear propagation resistance, very good damping and/or resilience, high impact strength and advantageous continuous service temperature and/or low-temperature flexibility as well as the hydrolysis resistance of TPU have proven to be very advantageous for use as the base material of a hoof protector. Furthermore, polyester-based TPU has good resistance to microorganisms, which is particularly advantageous and significant in the long-term use of hoof protectors made from this material. For the thermoplastic manufacturing method and post-processing, such as thermal welding, the reduced fume formation and toxicity of polyester-based TPU is of decisive advantage.

Mechanical loads on the TP as a function of temperature are to be determined for example in accordance with ISO 6721 2. Uniaxial tensile stress such as toughness, cold impact strength and impact strength is relevant for the equine's tread or impact scenarios, wherein the latter is determined for example according to ISO 179 /1eU. In contrast, the oscillating load, which is relevant for the equine hoof mechanism, is determined in accordance with DIN 53442.

In one embodiment, the mantle is formed from a thermoplastic polymer of one hardness, or at least two-layered from at least two thermoplastic polymers of the same or different hardnesses.

Through partial body production of the mantle, e.g. by first casting the bottom side and then the top side of the base plate, the formation of blowholes can be advantageously reduced or avoided, which improves the mechanical stability of the base plate.

Preferably, in relation to a vertical section of the hoof protector sole, a first thermoplastic polymer is arranged at the top and a second thermoplastic polymer at the bottom, wherein the first polymer preferably has a lower hardness than the second thermoplastic polymer.

In this way, it can be advantageously achieved that special inserts (e.g. damping inserts) do not have to be glued to the base plate. Instead, the damping properties of the base plate can be adjusted by the upper first polymer.

In one embodiment of the invention, the base plate of the hoof protector sole is made of solid material.

According to a preferred embodiment, the base plate of the hoof protector sole is therefore designed as a solid material. A solid material, in the sense of the invention, comprises a homogeneous mass of the same material.

The object of the invention of the hoof protector made of one and the same thermoplastic material (as defined herein) thus solves, for example, the disadvantages of the multi-component problem as described under the point prior art. The avoidance of mechanical, thermal or physiological incompatibility of materials means a significant reduction of safety risks when used as intended and increases the useful life of the hoof protector sole and also promotes environmentally friendly recycling of the hoof protector sole. The Shore hardnesses defined herein have proven advantageously for the solid material design of the hoof protector sole, wherein a preferred design of a solid material hoof protector sole comprises a Shore hardness of at least 50-95 Shore(A).

Furthermore, according to an embodiment according to the invention, all components/modules of the hoof protector sole can be formed from the same thermoplastic material. The use of a single thermoplastic material for all modules of the hoof protector sole, particularly preferably the entire hoof protector, maximizes the technical usability of the optimal properties of the TP for the application. In this way, the general advantages of the TP are technically utilized.

An example according to the invention of the extensive technical utilization of the advantages in the particularly advantageous use of a TPU as a solid material for a hoof protector according to the invention is given in the use of thermoplastic urethane (TPU) as the base material of the hoof protector, as described in a particular embodiment of the hoof protector according to the invention. In this embodiment of the invention, the use of TPU as the base material of the hoof protector results, for example, in a low density and various (physico)chemical properties, which are very advantageous for a hoof protector. The acid and alkali, UV and oxygen resistance of the TPU furthermore advantageously enables long-term durability of the TPU-based hoof protector sole, particularly preferably of the TPU-based hoof protector in the field of requirements of a horse (e.g. corrosive and microbially contaminated ground of the stable floor, weather conditions, actinic stress such as solar radiation).

Furthermore, the physicochemical properties of a TP, for example a TPU, such as the heat resistance and the softening point, are conducive to the economical, thermoplastic production of the hoof protector. The mechanical properties of the TPU, such as hardness, advantageous shock-absorbing properties, low elongation at break and high impact strength, are of particular relevance for hoof protectors and fulfill herein the complex requirement profile of a hoof protector as discussed above.

Furthermore, the static and dynamic friction properties of the TPUs as base materials of a hoof protector according to the invention, wherein the hoof protector according to the invention comprises the entirety of the TPs as base materials of a hoof protector sole according to the invention, particularly preferably a hoof protector, reduce a slipping on hard or even surfaces (for example tar or pavement). In this way, a significantly increased safety of the gait compared to conventional iron shoeing is made possible. The slip resistance describes a physical force effect between two contacting surfaces, in this case the hoof protector sole and the ground surface, which prevents the surfaces from moving relative to each other.

In order to subsequently adapt the shape of the hoof protector, in particular the hoof protector sole, to the exact shape of the hoof and to optimally adapt the individual movement mechanics of the animal when used as intended, wherein the hoof protector sole, in particular its base plate, is designed in such a way that it can be easily machined, so that up to 50% of the mass of the hoof protector sole material or the material of the base plate can be mechanically removed. The shape of the hoof protector sole can therefore be sawn out, flexed or cut to size corresponding to own drawing impressions and thus individually adapted. Due to this machinability, the use of the hoof protector is also possible over longer periods of time.

In summary, TPs, described as TPU in an inventive embodiment, have all the positive properties of the most common hoof protector to date (the horseshoe), such as individual adaptability, permanent usability on a horse's hoof and high abrasion resistance, wherein the negative properties of the horseshoe, such as high weight, damage to the horn and a high risk of injury, are no longer present. Furthermore, TPU is recyclable and can therefore be disposed of or reprocessed in an environmentally friendly way.

The use of the same base material in a hoof protector sole and a hoof protector lug system and the simultaneous provision of a high quality hoof protector is made possible by the idea that the same chemical base material (e.g. thermoplastic polyurethane, TPU) is used to provide the various different properties needed to provide a high quality hoof protector (e.g. damping, fit, hardness, slip resistance, abrasion resistance, elasticity). In particular, the use of TPU for all parts of the hoof protector enables the production of a long-term high performance hoof protector designed for the versatile use of the equine.

In one embodiment of the hoof protector sole, the base plate comprises at least a core and a mantle surrounding the core, wherein the mantle is formed from the thermoplastic polymer. Preferably, the core is formed entirely or partially from the same material as the mantle surrounding the core, or is formed from a different material than the mantle.

By choosing the same material for the core and mantle, chemical equivalence is advantageous, which can improve the bond between the core and mantle

In a further development, the core is provided with a coating which serves as a mediator in order to advantageously achieve better adhesion of different materials.

An alternative embodiment comprises an essentially modular base plate of the hoof protector sole consisting of at least one core and a mantle surrounding the core. Thereby, the core can be made of thermoplastic material, preferably of a material that is chemically compatible with the mantle. Particularly preferred is a chemical compatibility of the materials of the mantle and core due to the technically relevant advantages in the manufacturing method.

In a preferred embodiment, the shape of the mantle corresponds to that of the base plate.

Furthermore, the core is preferably designed with orthogonally aligned elevations on the top side, which enable an improved hold of the enclosing mantle or a connection with the material of the mantle.

In addition, the core preferably has small circular recesses which can be advantageously filled by the melt of the surrounding material of the mantle during manufacture, so that the cohesion of the core and mantle is improved. This reinforced bond between the core and mantle has an advantageous effect on the longevity of the hoof protector sole.

The modularity of the core and mantle allows the properties of both modules to be selected and adjusted independently. In this way, the individual requirements of the equine hoof mechanism and the mechanical requirements of the ground conditions can be better taken into account than is possible with a hoof protector made of solid material. By integrating a core with material properties that differ from those of the mantle, for example, the hardness of the hoof protector sole can be modulated in a targeted manner.

The core of the hoof protector sole may be selected from the same material as that of the mantle. Suitable materials are disclosed herein and include, in particular, the thermoplastic polymers defined herein.

In one embodiment, the core of the base plate of the hoof protector sole is made of a material that is softer than the mantle (i.e. the Shore hardness of the core material is lower than the Shore hardness of the mantle material), which promotes a shock-absorbing effect on the hoof side so that compressions of the equine's joints can be elastically absorbed. Preferably, the Shore hardness of the core material is therefore at least 10 Shore, particularly preferably at least 20 Shore, less than the Shore hardness of the mantle material.

In a preferred embodiment, the core provides an insulating element that is a customizable therapeutic agent and beneficial to an equine's individual hoof mechanism. Given that the mantle, which is harder in relation to the core, constitutes the majority of the base plate material, the hardness of the hoof protector sole is insignificantly reduced in this embodiment. In this way, a shock-absorbing and at the same time stable hoof protector is provided, which is particularly advantageous when used under mechanically demanding conditions or abrasive ground conditions and reduces the intervals between re-shoeing under these conditions. Adhesion in the sense of the invention refers to the static friction of one surface on another, for example the surface of the hoof protector sole on the ground surface, which prevents slipping.

The requirement profile of a material of a core of the base plate of a hoof protector sole overlaps with that which applies to the base plate and/or the mantle of an air protector, wherein further parameters for an optimal base material of a core can be taken into account. Further criteria which are significant for the suitability of a base material for the core corresponding to the application according to the invention can be described as weather and dimensional stability, low water absorption and good resistance to many chemicals as well as dimensional stability under heat. Dimensional stability under the influence of heat is particularly important for the production of the core via injection molding, as in this method the core is enclosed by the heated, plastic mantle material, the hardening of which the core must survive in a dimensionally stable and form-fitting manner. Dimensional stability under heat is determined in accordance with ISO 75.

This requirement profile is fulfilled by saturated polyesters based on thermoplastic polybutylene terephthalate (PBT). An exemplary embodiment of the invention is therefore the use of thermoplastic polybutylene terephthalate (PBT) as a base material for a core. It has been shown that thermoplastic, semi-crystalline, saturated polyesters based on PBT are advantageously used in this embodiment of the hoof protector according to the invention. In particular, it has been shown that glass fiber-reinforced, thermoplastic, semi-crystalline, saturated polyesters based on PBTs are advantageous for the use and manufacture of the hoof protector according to the invention. Derivatives of this embodiment can be modified in many ways and are a very good technical suitability as a base material for a core of a hoof protector. The technical suitability of these designs is characterized by high rigidity and strength, very good dimensional stability in heat, low water absorption, excellent dimensional stability, good sterilizability, high surface quality, excellent long-term thermal behavior and good resistance to many chemicals. In addition, the PBT-based cores show excellent weathering resistance and excellent heat aging behavior. It is preferred to use plastics for the mantle and the core which can form a chemical bond. In a preferred embodiment, PBT-GF30 is used for the core, especially if the mantle is made of TPU.

The core may further comprise foamed TPU base material which, to the knowledge of a person skilled in the art, is made possible by the addition of defined amounts of water during polymer synthesis, which produces carbon dioxide gas as a condensate so that foaming is induced. The thermoplastic base material of the core of the hoof protector sole can have foamed TPU pellets, which promote the cushioning properties and durability of the modules.

On the other hand, a requirement for ground-side hardness of the hoof protector sole material can be met by a harder core (i.e. the Shore hardness of the core material is higher than the Shore hardness of the shell material). In this way, modularity potentiates therapeutic effects, especially when the hoof requires high protection against mechanical stress.

In an alternative embodiment of the modular hoof protector sole, the core is therefore designed to be harder than the mantle, which promotes adhesion and/or ground-side support of the gait of the equine without compromising the stability of the entire hoof protector sole. This design is particularly applicable, for example, to equestrian sports in the field, such as eventing. Therefore, a core material is preferably selected whose Shore hardness is therefore at least 10 Shore, particularly preferably at least 15 Shore, higher than the Shore hardness of the cover material.

From the two embodiments hard core-soft mantle and vice versa, depending on the requirements, suitable materials for the core include both soft polymers (e.g. silicones) as well as hard polymers as the materials of the mantle.

Since the manufacturing method according to the invention via injection molding is a method with high demands on the shape and dimensional accuracy of the molded bodies obtained, the modular production of partial bodies is advantageous from a method engineering point of view. Herein, shrink holes refer to cavities that arise during the solidification of cast parts and can therefore occur during the injection molding of thermoplastic molded parts. More precisely, shrinkage refers to the volume loss of the material during cooling TP from the melt, which begins in particular when the temperature falls below TG and can continue at least until the solidification temperature TS. It has been shown in the invention method that the production of partial bodies prevents the formation of shrink holes.

The probability of shrinkage increases with the material thickness of a molded body, so that it can occur, especially when large injection molds are produced, and can generally impair the shape and dimensional accuracy of the molded body. In order to avoid or at least significantly reduce the formation of shrink holes during the injection molding method, it is also preferred that the base plate of the hoof protector sole consists of at least a core and a mantle. According to a preferred embodiment of the invention, the core is thereby provided in a first step, which is sheathed in a second step.

In the manufacturing method according to the invention, it has proven to be advantageous if the core is chemically compatible with the material of the mantle, as this makes it possible to physicochemically bond the two modules at the surfaces of the mantle, for example by fusing. This chemical material compatibility has advantageous technical effects for the strength of the bond between the mantle and the core integrated therein, because the physicochemical bond strengths are orders of magnitude greater than the pure adhesion forces between chemically less compatible materials. According to a particularly preferred embodiment of the present invention, the core is made from the same thermoplastic (base) material (e.g. TPU), particularly preferably from the same thermoplastic material (e.g. TPU-80(A), TPU-86(A), TPU-87(A), TPU-89(A), TPU-90(A), TPU-91(A), TPU-95(A), TPU-96(A) or TPU-53(D), TPU-58(D), TPU-75(D), TPU-80(D) or mixtures) as the mantle.

The quality, in particular the molding precision, of thermoplastically molded bodies, such as by injection molding, differs with the material properties of the respective TPs. An optimal thermal method control of the thermal primary molding, in particular the injection molding method, is specific to the chemical nature of the thermoplastic material. The thermal method control takes into account unavoidable material-specific thermoplastic modifications, such as expansion or contraction, in order to prevent the shape of the molded part from deviating from the actual desired shape. Therefore, the choice of physicochemically similar TPs for comparable method control in accordance with the invention is particularly beneficial for the quality of modular products. It has been shown that shrinkage can be reduced by the use of chemically similar TPUs. In accordance with the inventive thought, maximum chemical compatibility of the molded parts of a hoof protector sole goes hand in hand with maximum stability of the same.

The use of chemically compatible materials for the modular hoof protector according to the invention provides advantages for its disposal after its useful life. Modular products made of modules of chemically compatible materials can be recycled in a common recycling method for the core and the mantle, without the need for dismantling the hoof protector, so that its material can serve as a base material for manufacturing further molded bodies of the same material. The entire hoof protector can thus be advantageously subjected to a joint recycling method to recover the base material. The recycled material could serve as a base material for the same type of hoof protector sole or for a lug system as well as for the entire hoof protector. In principle, the recycled material can also serve as a base material for the manufacture of other products. Consequently, the use of chemically compatible materials for the modular hoof protector according to the invention advantageously enables cost and effort savings, as the modules can be disposed of and/or recycled together.

One embodiment of a hoof protector sole made of solid material aims at maximum stability and/or durability at minimum manufacturing costs with particular suitability for the leisure sector, whereas one embodiment of the modular hoof protector sole made of core and mantle aims at maximum customizability and therapeutic effectiveness.

In one embodiment of the hoof protector sole, a recess is arranged in the base plate in an area around a horizontal center.

According to the invention, a recess is arranged in the base plate of the hoof protector sole in an area around the horizontal center. The recess makes the horseshoe particularly light and at the same time advantageously counteracts a sealing of the bottom side of the hoof, which is disadvantageously known from the prior art. A sealing is a sealing of a surface while avoiding material exchange. The avoidance of sealing means the preservation of the natural self-regulation of dynamic exchange processes on the bottom side of the hoof, in particular of moisture. On the one hand, the recess avoids trapping decay pathogens already present on the surface of the horn on the underside of the hoof, as is the case with sealing. As these are mainly anaerobic bacteria, i.e. germs that multiply in the absence of air, the recess effectively prevents the formation of a breeding ground for parasitic germs and putrefaction.

On the other hand, the cavity formed by the recess in the hoof protector sole between the base plate and the equine hoof advantageously promotes air circulation in the sense of the natural dynamic exchange processes of the underside of the hoof. In this way, the accumulation of moisture or wetness and/or microbial activity can be avoided or reduced to a minimum by the air circulation achieved. This support of natural circulation is significant for the long-term use of the hoof protector on the equine hoof and is particularly important for therapeutic purposes. In this respect, the hoof protector sole according to the invention enables long-term use of the hoof protector as an alternative to metal shoes, which are not suitable for use as therapeutic hoof protectors due to their high weight and the use of nails, among other things.

In one embodiment, the base plate essentially comprises a U-shaped design.

In one embodiment of the invention, the hoof protector sole has a U-shaped design of the base plate which, when used as intended, follows the symmetry of a hoof. A U-shaped design can be understood as a synonym for horseshoe-shaped. For the purposes of the inventor, the intended arrangement of the hoof protector sole on the hoof is defined such that the U-shaped design of the hoof protector sole mirrors the shape of the heels, wherein the apex of the U-shaped base plate is arranged at the toe of the hoof and the thighs of the U-shaped base plate are arranged in congruence with the side walls, running out onto the heels.

In one embodiment, the thighs of the U-shaped design of the base plate are connected to each other via a bridge. Preferably, the bridge comprises an arch-shaped material recess and a wedge-shaped material recess. The shape of the material recess is adapted to each other in such a way that the thighs of the base plate follow as natural a movement/gait as possible (e.g. spreading of the hoof during gait).

A possible destabilization of the base plate at the thighs of the U-shaped design of the hoof protector sole is counteracted by a bridge (4.0) according to the invention, which connects the separate thighs of the U-shaped base plate of the hoof protector sole, in particular in the distal section of the thighs. The functional design of the bridge enables at least two independent technical features, which are set out below.

On the one hand, the bridge acts as a stabilizing means for the thighs, which are aligned with each other and are exposed to constant forces when used as intended. On the one hand, irregular vertical force vectors act, for example due to uneven ground when the horse steps on it; on the other hand, vertical force vectors corresponding to the hoof mechanism of the horse act constantly, particularly on the thighs of the U-shaped base plate of the hoof protector sole. The bridge promotes dimensional stability of the hoof protector by connecting the thighs, which is not only essential for a long wearing time, but also provides effective support for the natural hoof anatomy. In this way, detrimental shearing of the heels of the hoof is effectively avoided when the hoof protector sole is positioned on the hoof as intended.

Secondly, when the hoof protector sole is positioned on the hoof as intended, the bridge achieves maximum flexibility of the thighs—in accordance with the nature of the hoof mechanics in the corresponding area of the hoof. During the invention process, the wall thickness, the thickness, the shape and the position of the bridge were optimized with regard to maximum flexibility and the best possible promotion of dimensional stability of the base plate. The arch-shaped material recess on the top side and the wedge-shaped material recess on the bottom side of the bridge promote the two described technical effects of maximum flexibility and stability of the hoof protector sole.

In one embodiment, the recess comprises a perforation plate.

In one embodiment, the thickness of the perforation plate is reduced by at least 50% in relation to the thickness of the base plate.

In one embodiment, the perforation plate is arranged horizontally at the height of the base plate in such a way that the perforation plate is neither in contact with the hoof nor with the ground.

Preferably, the base plate comprises a perforation plate, wherein the perforation plate is not in contact, in particular not n direct contact, with the hoof and/or the ground, wherein it is related to a substantially flat surface/ground.

In one embodiment, the perforation plate can be removed via a circumferential framing with a low material wall thickness at the edge of the recess.

Preferably, the perforation plate is connected to the base plate via a circumferential framing, wherein the material thickness of the circumferential framing is less than a quarter of the height of the GP. Furthermore, the material thickness of the circumferential framing is preferably less than one-fifth or less than one-sixth of the height of the base plate. Advantageously, a thinner material thickness of the circumferential framing makes it easier to separate the perforation plate from the base plate, e.g. using a cutting tool.

In a preferred embodiment of the hoof protector sole, the recess of the base plate comprises a perforation plate (3.2). A perforation plate within the meaning of the invention comprises a plate interspersed with open recesses (in particular a perforation or a grid through the perforation plate). In this context, perforation means that the perforation plate can be designed both as a grid and with a continuous perforation. It is particularly preferred that the perforation plate has continuous perforations.

The individual holes of a continuous perforation plate that penetrate the perforation plate can have any conceivable shape, e.g. round, triangular or square.

The individual holes of a continuous perforation, which penetrate the perforation plate, can be arranged regularly or irregularly within the perforation plate.

It has been shown to be particularly suitable to have a continuous perforation in which the holes have a diameter of less than 15 mm, particularly preferably less than 10 mm, very particularly preferably less than 7 mm, even more preferably less than 4 mm. On the one hand, this can prevent the penetration of small impurities or foreign bodies (e.g. stones), which can cause undesirable injury or irritation to the equine animal's hoof, wherein air circulation is ensured at the same time. With the aforementioned diameters of the perforation plate holes, a number of 4 holes per 4 cm² has proven to be completely sufficient to achieve the associated advantages.

For example, the perforation plate protects the soft hoof sole (i.e. the bottom side of the equine's hoof) from penetration and mechanical influences from interfering or foreign bodies. The number, shape and size of the perforations are effective both for the stability of the perforation plate and for its protective effect on the hoof. The inventor has found that a conical shape of the opened recesses is particularly advantageous, wherein the perforation on the side facing away from the hoof has a smaller cross-section than on the side facing the hoof. The conical shape of the opened recesses prevents foreign bodies such as stones or sticks from penetrating and becoming trapped in the best possible way and encourages them to fall off during the equine's gait.

The perforation plate preferably fills the recess in such a way that continuity of the perforation plate with the hoof protector sole is formed via a preferably circumferential framing.

In a further embodiment, the preferably circumferential framing, which connects the perforation plate to the hoof protector sole, is of a thinner material thickness than the perforation plate, so that the framing acts as a nominal interface. In this way, the perforation plate can be removed if necessary using a cutting or trimming tool (e.g. a taping knife) at the target interface. The perforation plate leads to significant technical effects, which are explained below.

According to the invention, the perforation plate is arranged in such a way that it does not exceed the boundaries of the top and bottom sides of the base plate. The protection of the soft hoof sole against mechanical influences is technically optimal if the thickness of the perforation plate is varied in relation to the thickness of the base plate in one embodiment, preferably reduced, particularly preferably reduced by at least 50%, very particularly preferably by at least 60%. The reduced thickness also advantageously saves material and thus weight and costs. Furthermore, the perforation plate designed in this way advantageously promotes air circulation on the bottom side of the hoof, so that the hoof protector sole acts as an air chamber system when used as intended. This air chamber system supports the natural and dynamic exchange processes on the bottom side of the hoof, as discussed above.

A preferred embodiment of the perforation plate of the hoof protector sole and the hoof protector sole for the therapeutic area is its coating with substances with an antimicrobial effect, such as silver-containing coatings or silver-containing composite materials. The coating is preferably arranged on the side of the hoof protector sole facing the equine animal's hoof in order to counteract wear of the coating during the intended use of the hoof protector sole. Alternatively, the base material of the hoof protector sole or at least the perforation plate can be made of a composite material containing silver in order to provide antimicrobially effective hoof protection.

Both the air circulation and the mechanical protective effect of the soft hoof protector sole are significantly increased by a perforation plate arranged horizontally at the height of the base plate of the hoof protector sole, so that the perforation plate is neither in contact with the hoof nor with the ground.

As an alternative embodiment of the perforation plate, a grid is possible, which refers to a grid-shaped arrangement of elongated parts, preferably evenly spaced. Since two crossed layers of individual parts can preferably be used for a lattice, the thermoplastic production of a lattice is simpler and therefore also associated with a price advantage.

In summary, the type of perforation, the layer thickness and the arrangement of the perforation plate in the recess of the hoof protector sole create functional cavities that are conducive to exchange processes on the bottom side of the hoof and to preventing foreign body accumulation. The edging of the perforation plate allows the perforation plate to be easily removed if necessary, for example if frequent application of care products to the underside of the hoof is required in the course of therapeutic treatment.

In a preferred embodiment of the hoof protector sole, at least one extension (3.8), preferably aligned orthogonally to the base plate, is formed on the outside of the base plate or the outer edge of the base plate. An extension refers to an extension formed from the outside of the base plate or its outer edge. On the one hand, an extension enables an improved hold and/or the prevention of slipping between the hoof of the equine and the base plate of the hoof protector sole during the intended use of the hoof protector in everyday life. On the other hand, the extension enables simplified fixation of the hoof protector sole during its attachment to the hoof sole of the equine. For this purpose, at least one extension is particularly advantageously arranged at the apex of the base plate. Nevertheless, at least one further extension can be provided on the flanks of the base plate.

In a particularly preferred embodiment, the bottom side of the base plate of the hoof protector sole has profiling (5.1) or a profiling relief. In particular, the bottom side of the base plate has a profiling with a wing-shaped pattern. By profiling is meant the indentation of the surface of an original molded body, in this case the base plate of the hoof protector. The profiling gives the bottom side of the hoof protector correspondingly shaped elevations (5.2) and/or recesses (5.1) in cross-section, which effectively counteract slippage of the hoof provided with a hoof protector on the ground tread surface. In line with this inventive thought, the recesses in cross-section preferably have a proportionate depth, preferably of a quarter, particularly preferably of a third of the (total) thickness of the base plate. In this way, when the hoof protector sole is used as intended, a maximum slip resistance is promoted with simultaneous dimensional stability of the hoof protector sole. The profiling and the intrinsically advantageous sliding friction properties of the material of the hoof protector sole have a synergistic effect on improved slip resistance, so that an increased safety of the equine's gait-especially compared to conventional hoof protectors with iron shoes-can be achieved.

Furthermore, the design of the profiling relief according to the invention results in effective support for the natural hoof mechanism of an equine. The hoof mechanism describes the elastic deformation of the horn capsule during loading and unloading. The deformation of the hoof capsule under the load of the horse affects the parts of the hoof differently. Some parts of the hoof are compressed and others are stretched, which ensures optimum shock absorption of the physical forces during gait as well as blood circulation during gait mechanics. In one embodiment, corresponding to the rather static toe of the hoof, the front side of the profiling, when arranged as intended at the height of the equine's toe, of the base plate of the hoof protector sole has an arch-shaped, rather solid and thus stiffening elevation, while the thighs of the hoof protector sole are equipped with comparatively richly parceled and thus more flexible elevations. The shape of the elevations thus follows the force vectors, as a person skilled in the art would describe them as the natural force vectors of hoof mechanics.

The parceled elevations of the profiling of the thighs of the base plate result in a wing-shaped pattern in top view, which, in addition to the force-mechanical elasticity corresponding to the hoof mechanism, also enable wing-like flexibility of the thighs of the preferably U-shaped base plate. More precisely, this type of profiling on the thighs of the preferably U-shaped base plate means that the thighs can move in a wing-like, elastic and independent manner and thus meet the dynamic requirements of the hoof in place of the widest stretching when the equine is stepped on.

A wing-shaped design of the tread allows advantageously that dirt/mud is better drained to the outside and the horse therefore runs less risk of slipping.

In summary, the profiling of the hoof protector sole according to the invention absorbs, at least in part, operational loads on the hoof protector-of a dynamic nature due to the force flow of the gait mechanism or of a static nature due to the growth of the hoof walls over time mechanically to an elastic deformability of the hoof protector without impairing the quality of the attachment of the base plate to the hoof. The cushioning deformability of the hoof protector obtained by this profiling design according to the invention reproduces the natural hoof mechanism and is therefore beneficial to the health of the equine animal's overall gait. As advantageous side effect, the profiling according to the invention results in material savings, so that the product price savings can be passed on directly to the consumer.

According to a preferred embodiment of the invention, the profiling is positively connected to the base plate. This means that the base plate or at least the mantle of the base plate is preferably formed as solid material.

Preferably, the profiling is formed in whole or in part from at least one single profile element, wherein the single profile element can be arranged in the bottom side of the base plate by means of a form-fit connection. A form-fit connection is realized, for example, via screws, nails, click and/or snap connections. Preferably, an established form-fit connection is reversible, so that a single profile element can be removed from the bottom side of the base plate and/or replaced with another single profile element.

Interchangeable single profile elements have the advantage that the damping properties of the different areas of the hoof can be adapted. At the front or on the side of the hoof/base plate, the corresponding combination of single profile elements can therefore be used to set a different damping than is the case on the rear side of the hoof/base plate.

In a further embodiment, in addition to single profile elements with different damping properties, single profile elements with different heights in relation to the height of the base plate are also realized. In this way, a single profile element can advantageously be used to compensate for different heights of the hooves.

In one embodiment, a receiving eyelet is arranged horizontally to the base surface at the center of gravity.

For the purpose of storing the hoof protector sole, a receiving eyelet is preferably arranged horizontally to the base surface of the hoof protector sole at the center of gravity, which enables the hoof protector sole to be suspended and thus enables the hoof protector sole to be stored in a space-saving manner. The receiving eyelet can be easily removed after the hoof protector sole has been attached to the hoof of the equine. According to the invention, removal of the receiving eyelet is possible, for example, at a nominal interface with a lower material wall thickness, which can be arranged at the connection point of the receiving eyelet and hoof protector sole.

In one embodiment, the base plate comprises, perpendicular to the horizontal extension of the base plate, at least one perforation for additional nailing to the hoof of the equine.

In one embodiment, the base plate comprises anti-slip nubs on the side facing the hoof, the hardness of which is greater than that of the hoof at the supporting edge of the hoof.

The inventive intention of additionally improving the attachment between the hoof and the hoof protector sole results in a design of the base plate with anti-slip nubs on the side facing the hoof. According to the invention, anti-slip studs, denoting a bump-like elevation on a surface of the base plate, are harder than the supporting edge of the hoof. In this way, the material of the base plate can be interlocked with the contact surface on the supporting edge of the hoof in order to increase the static friction advantageously for the strength of the connection or attachment between the hoof and the hoof protector sole.

The anti-slip studs can take the form of hemispheres, endless wedges and pyramids as well as truncated pyramids and/or truncated cones.

In one embodiment, the base plate comprises at least one insert on the side facing the hoof, wherein the hardness of the insert is less than that of the material of the base plate.

A further possibility for improved fastening between the hoof and the hoof protector is realized according to the invention by means of inserts. Thus, the base plate and/or the hoof protector lug system, in particular the lugs in a particular embodiment, can comprise on the side facing the hoof an insert made of rubber, latex, plastic, glass fiber or carbon fiber, the Shore hardness of which is less than that of the material of the base plate. These hoof and hoof protector sole inserts can serve other purposes as an intermediate layer. Inlays made of rubber, latex, plastic, glass fiber or carbon fiber are included according to the invention as a shock-absorbing intermediate layer. A particularly preferred embodiment of an insole for the therapeutic area are insoles with an antimicrobial effect, such as materials containing silver, or a combination of at least one of the aforementioned insole materials as a composite material containing silver. Composites refer to a material as a composite of several materials.

In one embodiment, the outside of the base plate comprises lighting devices. In particular, reflecting strips and/or Piezo-driven illuminants are arranged on the outer wall of the base plate. These advantageously increase the visibility of the equid in poor lighting conditions.

Since the product according to the invention is a hoof protector, the integration of protective components with far-reaching protective effects is advantageous for an embodiment of the invention, especially for equidae in use in road traffic, such as police horses. From a traffic safety point of view, one opportune embodiment comprises lighting devices in the outer side (i.e. the side facing away from the hoof) of the base plate of the hoof protector sole, in particular LEDs, preferably operated by providing the energy from piezoelectric elements also embedded in the base plate. These are embedded in the base plate in such a way that sufficient electrical power is provided by the piezoelectric elements during the equine's gait in order to operate the Piezo-driven illuminants.

As a result, the lamps are advantageously independent of an external power supply such as batteries or accumulators.

In different embodiments, the thermoplastic polymer comprises unreinforced thermoplastic polyurethane elastomer (TPU) having a hardness in the range of 50 to 98 Shore, most preferably TPU-57(D), TPU-75(A), TPU-80(A), TPU-86(A), TPU-87(A), TPU-89(A), TPU-90(A), TPU-91(A), TPU-95(A), TPU-96(A) or TPU-53(D), TPU-58(D), TPU-75(D), TPU-80(D) or mixtures thereof.

In one embodiment, the thermoplastic polymer comprises a density of less than 5 g·cm⁻³, preferably less than 1.5 g·cm⁻³, more preferably less than 1.3 g·cm⁻³.

In one embodiment, the polymer preferably has a tensile modulus of at least 50 mPa, preferably in the range from 60 to 100 mPa, particularly preferably in the range from 75 to 95 mPa.

Preferably, the hoof protector sole comprises nail counterbores. These are preferably openings that go through the mantle and the core. The nail counterbore advantageously allows the base plate to be nailed to the hoof, which can be done in addition to another fastening method (e.g. gluing or thermal welding).

The invention also relates to a hoof protector lug system made of a thermoplastic polymer for attaching a hoof protector sole according to one of claims 1 to 20 to a hoof of an equid, wherein the hoof protector lug system is formed from at least one collar and at least one lug, wherein the collar and the lug are connected to one another via a web area, wherein the web area connects the lug and the collar to one another via (n+1) webs which are formed by n recesses in the web area.

The hoof protector according to the invention further comprises a hoof protector lug system which, when used together with that of the hoof protector sole described in the previous part, synergistically provides new technical effects for the hoof protector according to the invention for the hoof of an equine and serves to attach the hoof protector sole to a hoof of an equine.

According to a preferred embodiment of the invention, the hoof protector lug system is formed from a thermoplastic polymer (as defined herein).

The hoof protector lug system is formed from at least one collar (8.3) and at least one lug (8.1), which are connected to each other via a web area in accordance with the invention.

A lug (8.1) is one side of a joint in which two pieces of flat material are connected in an overlapping manner. According to the invention, the overlapping connection is made to the hoof wall of an equine animal's hoof.

According to the invention, the collar (8.3) has a flat, rectangular base surface, which is provided according to the invention for the overlapping connection between the lugs and the base plate of the hoof protector sole. When the collar is positioned orthogonally to the base plate of the hoof protector sole, the rectangular base surface of the collar is flush and form-fitting with the outside of the base plate of the hoof protector sole and covers it when used as intended. Such a flat connection of the hoof protector lug system to the base plate has the advantage of a maximum adhesive surface and ensures a firm connection of both elements when they are connected flat. In this intended installation, the bottom side of the collar is flush with the lower boundary of the outer side of the base plate of the hoof protector sole.

According to the spirits of the inventors, the collar and one or the lug are connected to one another via a web area (8.2), which preferably comprises n recesses and (n+1) webs, which preferably enclose the recess and thus bridge the collar with the lug.

The shape of the recesses can be selected as desired (e.g. essentially flat, round or angular). A preferred recess shape is an ellipse, preferably a Lamé oval, also known as a superellipse. The superellipse refers to a geometric figure as an approximation of the geometry of an ellipse to the geometry of the rectangle. The elliptical shape of the recess is preferably flush with the bottom side of the collar on the long side. In the design of the recesses of the web area, the technical intention is to maximize the torsional strength of the lugs in relation to the collar or the hoof in relation to the hoof protector sole. Due to the n+1 bridging of the webs between the collar and the lug of the hoof protector lug system, the torsional forces of hoof movement are not only reduced by the area of the recess when the hoof protector is connected to the equine hoof as intended, but the torsional forces are transmitted independently for each web. These two technical effects contribute significantly to an effective decoupling of the movement mechanics of the hoof and hoof protector sole when the hoof protector is attached to the equine's hoof as intended, and thus enable maximum elasticity of the hoof protector without loss of stability of the connection between hoof and hoof protector sole, and/or without loss of long-term stability of the hoof protector attachment.

In one embodiment, the hoof protector lug system comprises at least one fold arranged between the collar and the lug.

In one embodiment according to the invention, the hoof protector lug system comprises a fold area (8.5). A fold refers to an edge, a bend or an L-shaped configuration of a flat body, so that advantageously a tiltability or angulation of flat bodies along the fold is given. Preferably, the fold is arranged between the lug (8.1) and the collar (8.3), particularly preferably above the web area (8.2). According to the invention, the fold is arranged parallel to the bottom side of the collar and/or, when attached according to the invention, horizontally to the ground contact area, so that an angular axis of the hoof protector lug system is arranged in the web area and parallel to the supporting edge.

From this arrangement of the angular axis, a degree of freedom is gained which allows the elastic character of the attachment of the hoof to the hoof protector sole without compromising the stability of the attachment. The fold thus reduces detrimental slippage of the two elements against each other, especially in the horizontal direction of force vectors. This horizontal elastic stability of a hoof in relation to the hoof protector sole is particularly important when the equine is accelerating positively, for example when changing to a higher gait such as trotting to galloping, or when the equine is accelerating negatively, for example when reducing the walking speed. The gain in elastic degrees of freedom due to the fold in the web area promotes the natural gait of an equine.

In one embodiment, the hoof protector lug system comprises at least two immediately successive folds, which are arranged between the collar and the lug.

In an inventive continuation of the fold, one embodiment of the hoof protector lug system comprises at least two folds in direct succession, collectively referred to as an offset. Due to the offset, two edges are arranged essentially parallel to the underside of the hoof. Preferred are directly consecutive folds, which are preferably arranged between the lug (8.1) and the collar (8.3), and particularly preferably above the web area (8.2). In analogy to the simple fold, the offset results in two degrees of freedom due to two angular axes. The effect of the two angular axes creates a significant gain in both horizontal and vertical elasticity. This results in an elastic controlled displaceability of a hoof in relation to the hoof protector sole, wherein a disadvantageous uncontrolled slipping of the two elements against each other is excluded. In contrast to a single angular axis (caused by the arrangement of a single fold, see previous point), a double angular axis (caused by the arrangement of an offset) also mechanically dampens the vertical force vectors of the hoof movement when loading and unloading the hoof of an equine. This promotes the elastic stability of the hoof protector on the hoof corresponding to the natural hoof mechanics of an equine. The technical effect of the double fold is therefore described as maximum elasticity against both horizontal and vertical load thrusts. As with the fold, arrangement of the offset prevents the hoof from detrimentally slipping in relation to the hoof protector sole.

In one embodiment, the lug of the hoof protector lug system comprises at least one layer of TPE on the side facing the equine's hoof. Preferably, the lug and/or the collar is formed from a thermoplastic polymer. This thermoplastic polymer can be the same polymer from which the mantle is formed.

It is of advantage if the degrees of freedom gained by the fold and/or the offset act synergistically with the inherent elasticity of a plastic polymer material of the hoof protector lug system. Meanwhile, according to the invention, the polymer of the hoof protector lug system is molded from a thermoplastic elastomer (TPE) as defined herein, preferably from a thermoplastic polyurethane (PU) material, more preferably from TPU.

The base material of the hoof protector lug system can also be made from modifications of TPU, for example glass fiber-reinforced TPU, polyester-based TPU and/or polyether-based TPU. Through this modification, in particular through the glass fiber reinforcement, good high stiffness values can be provided with good elongation, good resistance and good impact strength at the same time. Furthermore, glass fiber-reinforced TPU has a low coefficient of thermal expansion and good paintability.

The use of TPU as the base material of the hoof protector lug system also promotes its ability to follow the dynamics of hoof movement and the complex interplay of deformations of the horn capsule during the equine gait. The material of the hoof protector lug system supports the elastic decoupling of the hoof mechanism and the hoof protector, so that mechanical stresses such as shear forces, oscillations, vibrations and impacts between the elements of a hoof and a hoof protector are minimized.

In this inventive thought, a lug of the hoof protector lug system is comprised of at least one layer of TPE. In a further embodiment, the lug is formed from an elastomeric outer layer and at least one softer elastomeric middle layer, so that an arbitrarily fanned-out hardness-or elasticity gradient of the material of the hoof protector lug system extends from the outer layer of the lug facing away from the hoof to the inner wall of the lug facing towards the hoof. Ideally, this hardness gradient includes the properties of the optional adhesive layer that connects the lug of the hoof protector lug system to the hoof.

Preferably, the lug and/or the collar is constructed with at least two layers, wherein one of the layers is oriented on the hoof side and one of the layers is oriented away from the hoof and wherein at least one of the layers is formed from the thermoplastic polymer. Preferably, the hoof side oriented layer of the lug and/or the collar is meltable and can be bonded to a surface.

In one embodiment, the outer side of the hoof protection sole or the collar comprises at least one protrusion, which can be pressed into a melted thermoplastic polymer. In this way, it can be advantageously achieved that the collar can be connected to the base plate in a mechanically more stable manner, as described below. Such a protrusion can have various shapes and can be T-shaped, for example.

The lug of the hoof protector lug system serves as a planar connecting piece for the adhesive or welded connection of molded bodies, according to the invention as a direct connection between the hoof of an equine and the hoof protector sole.

In a technically effective embodiment the lug is essentially shaped as an isosceles trapezoid, which is tapered upwards from the web area. An isosceles trapezoid comprises two sides of equal length and parallel top and bottom sides of different lengths, wherein the two inner angles of the parallel sides are of equal size. Correspondingly, the top and bottom sides have an axis of symmetry orthogonal to them running through half their length.

On the one hand the trapezoidal shape of the lug means, that when the hoof protector lug system is attached according to the invention to the hoof of the equine animal, a maximum planar contact of the lug on the tapered hoof wall is promoted, without the lugs overlapping each other. The avoidance of overlapping of the lugs prevents poor adhesion of the lugs to the hoof surface when attached according to the invention. It is known to the person skilled in the art, that the shape of the hoof, including its conical structure (conicity), is directly related to the breed of the equine. The degree of conicity of a hoof requires a correspondingly pronounced angling of the lugs towards each other on the hoof in order to achieve the maximum contact surface of the hoof protector lug system, which is advantageously possible for a wide range of hoof shapes due to the trapezoidal shape of the lugs. As the usual angular dimensions of ideal hoof angles are between 45 and 50 degrees at the toe and between 50 and 55 degrees for the steeper heel area, individual adaptation of the lug to the hoof geometry is important for broad applicability and thus for the economic potential of the hoof protector lug system and hoof protection in general.

The trapezoidal design of the lug also enables a large surface area and thus a large contact area for attaching the lug. Such a large-surface lug of the hoof protector lug system has the advantage of a large adhesive surface on the hoof surface and ensures that the hoof protector is firmly attached to the horse's hoof. In conventional horseshoes attached to the hoof with nails, the forces are transferred via the nails, which inevitably leads to damage to the horn. In contrast to this, attachment by means of the hoof protector lug system according to the invention allows a more favorable distribution of the forces over the lateral surfaces of the hoof.

Optionally, a receiving eyelet (8.4) is arranged on the hoof protector lug system for the purpose of storage, preferably on the top side of the lug, which is recessed centrally to the axis of symmetry and to the top side of the lug.

In summary, the hoof protector lug system according to the invention favors, both in terms of material and shape, that the hoof protector can follow the movements of the individual elements despite the flat and firm connection on the hoof.

In summary, the web according to the invention enables technically significant effects, as forces and stresses occurring between the hoof protector and the hoof are elastically minimized, partial concentrations of forces due to large-area transmission are avoided, and in this way long-lasting connection stability is ensured.

### Attaching the Hoof Protector

The invention further relates to a method of attaching a hoof protector according to claim 25 to the hoof of an equid, wherein the method comprises the steps of: Firstly: cleaning and/or straightening the hoof surface, secondly: joining the hoof protector sole to the hoof protector lug system to form the hoof protector, thirdly: attaching the hoof protector to the thus prepared hoof surface, wherein the hoof protector is preferably attached to the prepared hoof surface free of nails by gluing and/or thermal welding.

In particular, the invention relates to a method of attaching a hoof protector to the hoof of an equine wherein the method comprises the following steps:
(i) Partial, by means of a temporary heat input, melting of at least one hoof side
oriented layer of at least one lug.
(ii) Bringing into contact at least a partially fused hoof side oriented layer of the lug with a hoof wall.
(iii) Thermal welding of the melted hoof side oriented layer of the lug to the hoof wall, wherein the thermal welding comprises cooling and material bonding connecting the hoof side oriented layer of the lug to the hoof wall.

In one embodiment, the hoof protector sole is joined to the hoof protector lug system to form the hoof protector by gluing and/or thermally welding the collar of the hoof protector lug system to the outer edge of the hoof protector sole.

In one embodiment, the hoof protector is attached to the prepared hoof surface by an adhesive connection of the lugs of the hoof protector lug system.

The method according to the invention for attaching a hoof protector to the hoof of an equid essentially comprises preparing the hoof, assembling the hoof protector from the hoof protector lug system and the base plate of the hoof protector sole, and attaching the hoof protector to the preferably prepared hoof surface without the use of nails.

More precisely, the method for attaching a hoof protector sole to a hoof of an equid is carried out by indirect and contact surface bonding, comprising at least gluing and/or welding, of the base plate of the hoof protector sole to the outer horn wall of the hoof of an equid via the hoof protector lug system. This is carried out in accordance with the invention step by step by joining a hoof protector lug system to the hoof protector sole before attaching the hoof protector to the hoof wall of the equine animal (sequential attachment).

To attach a hoof protector to the hoof of an equid, the hoof surface of the equid is first prepared by cleaning and/or the straightening. The cleaning can be carried out by removing foreign bodies such as dirt particles from the hoof surface and/or degreasing with a suitable agent, such as acetone. The straightening of the hoof surface refers to the professional preparation of the hoof by mechanical intervention on the horn capsule of the hoof as a targeted shortening of the hoof horn. It serves to restore the regular hoof shape to a strong, elastic hoof shape while avoiding progressive rotting processes, which depends on the husbandry (stable or pasture keeping), type of use (rearing, breeding, riding horse or driving horse), age, breed (physique, hoof and limb position) and health status of the equine and is carried out appropriately by a person skilled in the art. The straightening is particularly aimed at achieving a balanced pressure distribution pattern with regard to a hoof position that matches the ground contact area of the equine, which includes the hoof protector to be applied. The base plate is then preferably adapted to the shape of the lower cross-section of the professionally prepared hoof.

The preparation of the hoof surface and the adaptation of the base plate to the prepared hoof of the equine is followed by the joining of the adapted hoof protector sole with the hoof protector lug system to form the hoof protector. A joining in the sense of the inventor refers to the material-connecting and form-fitting joining of modules to form a new unit, which includes joining by means of welding and bonding. A bonding allows a mechanical force transmission between two surfaces via a (dried) adhesive, which results as the sum of an adhesive force, the adhesive force on the surface of different materials, and a cohesive force, the internal forces of the (solidified) adhesive, wherein the force effect usually takes place in the course of solidification of the adhesive by molecular cross-linking. Thermal welding refers to the non-detachable joining of modules using thermal energy. An optimal weld requires a material-related similarity of the joining partners. According to the invention, the use of physicochemically compatible materials, in particular thermoplastic polymers (TPs), enables the joining of the combination product by means of a plastic welded joint under the maxim of maximum adhesive force through the integration of chemical bond strengths.

According to the invention, the joining of the hoof protector sole to the hoof protector lug system takes place at the collar of the hoof protector lug system and at the outer edge of the base plate of the hoof protector sole, This joining is preferably realized by means of a plastic welded joint, wherein at least a part of the collar of the hoof protector lug system is attached to the outer edge of the thermoplastic base plate by means of partial melting. Methods for welding TPU are known from the prior art and are generally realized by heating elements, ultrasonic welding, rotation-and vibration welding or prospectively laser welding, wherein the latter is particularly advantageous in enabling a minimization of thermal stress for the

material and the user. A welding-friendly design of the joining surfaces and optimum processing parameters are known to the person skilled in the art from the corresponding DVS guidelines (German Association for Welding Technology). The high temperatures of approx. 200-400° C. required for partial melting of the thermoplastic base plate are achieved, for example, by providing a heat-generating welding device, preferably a hot air device. Through direct thermochemical bonding of the collar of the hoof protector lug system to the outer surface of the base plate of the hoof protector sole, a very strong connection of the modules is advantageously achieved. In this way, a loss-proof hoof protector is promoted. Alternatively, the joining of the base surface of the collar of the hoof protector lug system with the outer surface of the base plate of the hoof protector sole can be realized by means of adhesive fasteners.

The joining of the hoof protector sole with the hoof protector lug system to form the hoof protector follows, according to the invention, the attachment of the hoof protector to the prepared hoof. Preferably, the lugs of the hoof protector are attached over the entire surface of the hoof wall of the hoof of an equid, particularly at positions of the hoof wall which are conducive to a secure and long-term hold of the hoof protector on the hoof.

The attachment of the hoof protector to the prepared hoof surface is preferably done free of nails by thermal welding and/or (preferably) by gluing to the prepared hoof surface. The high temperatures required for melting the thermoplastic materials are generally not applicable for attaching the hoof protector to the hoof, as such thermal effects can cause irreversible damage to the horn material of the hoof and the lateral tissue. Therefore, the prepared hoof protector is applied to the hoof as an alternative to thermal bonding, wherein the focus is on quick application that is gentle on the hoof and has a high adhesion quality. The adhesive quality of the attachment determines the service life of a loss-proof hoof protector on the hoof. According to the inventor, the hoof protector is therefore attached to the prepared hoof surface of the hoof by means of a suitable adhesive connection of the lugs of the hoof protector lug system. This embodiment advantageously enables a particularly quick, uncomplicated and (thermally) gentle attachment of the hoof protector for the horse. A quick and uncomplicated attachment of the hoof protector to the equine is indispensable from a safety point of view for an equine and a hoof trimmer.

Under suitable adhesives for fastening, fast-curing and strong adhesives such as acrylate-based special adhesives, preferably one-component adhesives, particularly preferably cyanoacrylate adhesives, are included under the intended conditions. The properties of the adhesives included enable rapid curing of the adhesive at room temperature, a small change in volume during curing/cross-linking of the adhesive and a high adhesive quality even when curing under different conditions in which the horses are kept (cold, wet). Here, quality assurance measures and a quality check of the adhesive bond corresponding to the current test standards are appropriate, wherein the use of cyanoacrylate adhesive advantageously requires hardly any complicated (work) protection measures. Optimum adhesive properties generally require a pre-treatment, such as sufficient pre-drying, roughening, cleaning, degreasing and/or activation of the surfaces. The preparation of the hoof and/or horn substance of the equine hoof for the adhesive attachment using an adhesive can be carried out, for example, by leveling, cleaning and degreasing. A grease solvent, such as acetone, is suitable for degreasing.

The method of attachment according to the invention is-for example in comparison to attachment by means of nails susceptible to rust-non-invasive. Therefore, for adhesive attachment, as opposed to nailing, damage to the hoof advantageously does not occur, which would otherwise be caused by an increased susceptibility of the hoof to microbial colonization or decay or destabilization of the horn material. The non-invasive application is therefore beneficial for the treatment of existing inflammations of the hoof (e.g. laminitis). The non-invasive application of the hoof protector is generally advantageous for use in the healing of damaged horn material of the hoof or for conversion from conventional shoeing to bare hoof. Thus, the subject matter of the invention is further suitable as transitional protection of a horse between seasons or can be used during extended periods of riding of the horse.

The application of the hoof protector at room temperature according to the invention is advantageous for therapeutic treatment. The high temperature of the horseshoe when “burning” the iron onto the hoof is not insignificant, as the heat dries out the hoof and makes it brittle.

TPU parts can be joined cost-effectively using a variety of methods. The mechanical properties of TPU, especially its toughness, allow, for example, the use of nails or self-tapping screws to connect TPU molded parts to each other and to parts made of other materials.

Promoting such a firm connection of the hoof protector to the hoof by the aforementioned “nailing”, one embodiment of the base plate of the hoof protector sole comprises at least one perforation perpendicular to its horizontal extension for additional nailing to the hoof. The nailing, as a direct connection between the hoof protector sole and the hoof, represents an alternative or preferably additional reinforcement of the indirect connection of the hoof to the hoof protector via the hoof protector lug system according to the invention. The direct connection by means of nailing can be advantageous for areas of the hoof protector that are subject to particular mechanical stress, or can also be useful for non-therapeutic applications.

The sequential attachment of the hoof protector to the hoof allows advantageously integration of additional intermediate layers, for example between the hoof and the hoof protector. Additional intermediate layers are, for example, cushioning inserts. Alternatively, an adhesive intermediate layer can be made of melted base plate material or pressure-sensitive adhesive, for example rubber, to strengthen the adhesion of the hoof protector to a horse's hoof.

Finally, the described sequential order of attaching the hoof protector to the hoof of a horse advantageously enables the first step of assembling the hoof protector to proceed according to the maxim of stability and the second step of attaching the hoof protector according to the maxim of the fastest possible and most secure attachment of the hoof protector. For the application of the hoof protector according to the invention, this advantageously results in a long-term loss-proof, uncomplicated attachment of the hoof protector sole to the hoof of a horse when used as intended.

The invention also relates to a method of joining a hoof protector sole, in particular a hoof protector sole defined herein, and the hoof protector lug system defined herein, wherein the method comprises by the following steps:
(i) Partial, by means of a temporary heat input, melting of a surface of a hoof protector sole, in particular of a hoof protector sole defined herein, and/or of a surface of the collar of the hoof protector lug system, wherein the surface comprises a thermoplastic polymer defined herein.
(ii) bringing into contact of the melted surface with a non-melted surface of the hoof protector sole, in particular the hoof protector sole defined herein, or of the hoof protector lug system (8.0), or bringing into contact of the melted surface with a melted surface of the hoof protector sole, in particular the hoof protector sole defined herein, or of the hoof protector lug system.
(iii) Thermal welding of the melted surface to a non-melted surface or to a melted surface of the hoof protector sole, in particular the hoof protector sole defined herein and/or the hoof protector lug system, wherein the thermal welding comprises cooling of the melted surface and material bonding connecting of the surfaces.

By thermal welding is meant herein a method in which two surfaces are materially bonded together, wherein at least one of the surfaces is at least partially melted before bringing the two surfaces into contact, provided that it is formed from a thermoplastic material.

Combination product and its use

It is task of the present invention to provide a hoof protector, in particular a therapeutic hoof protector, which provides a permanently stable hold on the hoof and a non-invasive application.

The invention therefore comprises a hoof protector as a combination product of at least the hoof protector sole defined herein and the hoof protector lug system according to the invention. In particular, the invention relates to a hoof protector formed according to a method defined herein, wherein the hoof protector is formed from a hoof protector sole, in particular a hoof protector sole defined herein, and the hoof protector lug system defined herein.

In an inventive sense, the use of the hoof protector is designed as a combination product comprising the modules of the hoof protector sole and the hoof protector lug system made of TP. In a particular embodiment, the combination product is designed from modules of a chemically compatible TP, for example TPU, so that further advantages arise with regard to recyclability, as discussed above with regard to the recyclability of core-mantle modules.

It also relates to the use of a hoof protector sole, a hoof protector lug system, or a hoof protector for attachment to a hoof of an equine animal.

Also according to the invention is the use of a hoof protector as a combination product for attachment to a hoof of a horse. Equivalent according to the invention is the use of a hoof protector sole and a hoof protector lug system for attachment to a hoof of a horse.

The use of a hoof protector made of thermoplastic polymer, modularly consisting of the hoof protector lug system and a hoof protector sole, for attachment to a hoof of a horse enables a permanently stable hold by securely attaching the hoof protector to the equine, whose synergistic effects are described above. The permanent hold is advantageously possible from the use of TPs for both modules, the hoof protector sole and the hoof protector lug system, as its connection enables a particularly high strength. The inventive indirect attachment of the hoof protector to the hoof, as described above, further enables nail-free, non-invasive attachment by flat gluing and/or thermal welding of the modules of the hoof protector, the hoof protector sole and the hoof protector lug system.

A physicochemical compatibility of the components of the combination product is particularly advantageous for a firm connection of the modules to each other in the method of attaching the hoof protector and significant for the shock-absorbing properties of the hoof protector.

Furthermore, the combination product made of the same TP material enables both components to be manufactured by means of an injection molding method, and consequently an adjustable fit accuracy of the hoof protector sole and the hoof protector lug system to each other, which includes their customizable production with regard to their size and design.

The easy removability of the hoof protector according to the invention is itself very advantageous after the horse has died. Animal by-products are generally removed by a rendering plant, wherein the hoof protector must be removed for utilization of the dead horse's body. Due to the ease of removal of the hoof protector according to the invention by the horse owner, it is avoided that employees of the rendering companies have to carry out the removal of the hoof protector in front of the owner's eyes, especially since dead horses are generally not treated differently from slaughterhouse waste during rendering, so that advantageously emotionally stressful scenarios of the horse owner are counteracted.

### Manufacturing Method

The invention also relates to a method of manufacturing a hoof protector sole or hoof protector lug system by injection molding or 3D printing, wherein the following steps are included. First: providing a thermoplastic base material, Second: providing an injection molding machine or a 3D printer, Third: master molding by injection molding the base material into the hoof protector sole or the hoof protector lug system by injection molding machine or the 3D printer by thermoplastic processing, Fourth: Demolding the hoof protector sole or hoof protector lug system, wherein the thermoplastic base material is selected from one of the following materials: thermoplastic polymer, preferably thermoplastic polyurethane (TPU), particularly preferably polyester-based TPU.

The invention also relates to a method for producing a hoof protector sole, wherein the hoof protector sole comprises at least a core and a mantle enclosing the core, wherein in a first step the core is presented and in a second step it is enclosed in a form-fitting manner by the thermoplastic molding compound of the mantle by means of injection molding or 3D printing, so that the core is at least partially integrated into the mantle.

In addition, it is task of the present invention to provide a method by which the hoof protector defined herein with the described technical task can be manufactured with dimensional precision and dimensional accuracy and economically in large quantities.

Since the thermoplastic polymer (TPs) hoof protector according to the invention exhibits reversible deformability, this is used advantageously for the manufacture of the hoof protector via the master molding method. In the master molding method, a solid body with a geometrically defined shape is generally produced from a shapeless material. In contrast to alternative master molding methods, the injection molding method can achieve a high quality in terms of the shape and dimensional accuracy of the molded body obtained, which is particularly advantageous for the production of a hoof protector made of TP. An injection molding method refers to a discontinuous method for the production of molded bodies made of plastic by thermochemical molding, usually from granulated starting material. The granular form of the starting material enables good qualitative and quantitative dosing, so that good control over the placement in the method can be achieved. Furthermore, the granular starting material has a good shelf life and is generally available from specialist retailers, so that it is possible to react quickly to fluctuating demand in the discontinuous production of technical molded bodies using the injection molding method.

In this way, the injection molding method enables even complicated molded parts to be produced economically in large quantities, which is advantageous for the commercial manufacture of a hoof protector. Furthermore, the injection molding method generally makes it possible to produce precisely fitting molded bodies or partial bodies and/or modules of a molded body assembled to form a combination product, which is the subject of the inventive thought. A hoof protector as a combination product made of TP can be formed via injection molding, so that the hoof protector can be provided in one method and for each module in a technically efficient production step.

In general, the method steps of an injection molding method can be summarized as pre-drying, plasticizing and dosing, injection and cooling, and a demolding and ejection.

It is known to persons skilled in the art that pre-drying, especially of TPU materials, is beneficial in order to avoid side reactions. Furthermore, damage such as a loss of toughness of the manufactured molded body can occur if the moisture content is too high during the melting process during processing. It has been shown that a drying time of, for example, 2-5 hours at approx. 80° C. to 120° C. circulating air or approx. 70° C. to 100° C. dry air is successful for a maximum processing moisture content of 0.02% and thus advantageously leads to homogeneous melting processes.

In the injection molding method, the granulated starting material is first poured into a filling hopper and then thermally plasticized in the so-called injection unit, i.e. converted into a flowable state. A filling hopper refers to a container with a small opening through which the material can be poured into the injection unit without spilling. The injection unit, a closed conveying system, is used for plasticizing the plastic granulate under pressure and/or thermal energy and is usually designed as a rotating screw shaft which transports the granulate in the direction of the injection tool. As a plasticizing unit, a flat-cut three-zone screw is used according to the invention, so that a shorter dwell time of the mass in the barrel and a more uniform temperature distribution in the melt is made possible. When using TPU-90(A), for example, an injection unit temperature of 195-220° C. is preferred.

A non-return valve prevents the melt from flowing back out of the screw antechamber and thus reduces the occurrence of shrink holes. The choice of processing temperature and dwell time is highly dependent on the material, the flow path length of the melt, the machine geometry and the dwell time of the melt in the barrel. Too high melt temperatures and too long dwell times of the melt in the barrel can lead to thermal degradation of the polymer material, i.e. molecular degradation. The person skilled in the art can obtain more detailed information from the processing data sheet of the corresponding polymer material. For example, the optimum melt temperature for TPU-90(A) is approx. 220° C. During dosing, the screw peripheral speed and back pressure must be limited to ensure gentle material processing. The back pressure should thereby enable optimum melt homogeneity without subjecting the material to too high shear. A temperature gradient provides an alternative way of optimizing the melt homogeneity.

Subsequently the plasticized material is injected in a metered manner into an injection mold, i.e. the negative mold of the molded body to be formed. The surface structure and shape of the finished molded body are determined by the cavity of the tool. The optimum mold temperature is approx. 25-40° C.

The shrinkage, which results from the volume contraction of the cooling molding compound due to the change in the aggregate state and/or crystallization, refers to the difference between the cavity of the tool and the molded part at room temperature. Defined terms and measurement methods for the shrinkage are known to the person skilled in the art from ISO 294-4. The shrinkage generally depends on the shape and wall thickness distribution of the molded parts as well as other processing conditions in addition to various material parameters. The mechanical stability of preferred material embodiments of the invention advantageously enables low wall thicknesses for the hoof protector according to the invention, so that possible shrinkage of the molded body is minimized.

The quality and the properties of the molded bodies obtained by the injection molding method depend on further manufacturing and processing conditions. For example, the injection molding method can cause an isotropy of the physical qualities (e.g. flexural strength, elongation at break), provided that an orientation direction of the macromolecules corresponding to the injection molding direction is favored, especially in the case of fiber-reinforced modifications of the polymer material. Due to the orientation of the molecules, shrinkage can occur in the orientation of the flow direction, which is referred to as warpage. A warpage is particularly pronounced in fiber-reinforced TPs. Therefore, in a preferred embodiment of the object of the invention, an unreinforced thermoplastic urethane elastomer (TPU) is used, which has no fiber reinforcements and therefore advantageously reduces a warpage of the molded body.

After the cool down to room temperature, the molded body can be removed from the melt casting machine.

As discussed above, the molded bodies produced using the injection molding method can, for the most part, be further processed into individually adapted molded parts by machining after they have cooled.

In a particular embodiment, the thermoplastic polymer can be colored with dyes without altering its property profile, provided that good compatibility between the polymer and the dye is selected. For example, polybutylene terephthalate-based dyes are advantageously possible for coloring TPU-based hoof protectors. In this way, an individual optical design of the hoof protector is possible, which is of technical relevance for color identification.

I In general, any thermoplastic material that can be processed thermoplastically is suitable for the thermoplastic molding process, such as thermoplastic esters, ethers, amides and imides. The thermoplastic polymeric base material can therefore be selected from polyamide (PA), polyethylene terephthalate (PET), polybutylene terephthalate (PBT) or thermoplastic polyurethane (TPU) as well as other materials for thermoplastic molding. It is known to a person skilled in the art that a chemical variation of these base plastics, for example with glass fiber and/or carbon fiber, contributes to the modification of their properties, in particular to the reinforcement of the material. It is generally known that the article design is limited in its shape, size and material thickness despite the above-mentioned modifications of the base materials. Limitations arise, for example, for molded bodies of high material thickness and/or large dimensions, as artifacts such as shrink holes can lead to material failure on the molded body in its technical application. Therefore, from a process engineering point of view, some TPs are suboptimal for producing large molded parts. In particular, TPUs are predestined for thermoplastic primary molding of a hoof protector according to the invention due to their advantageous and/or advantageously adjustable physicochemical properties, such as the TG and/or their low thermal expansion. In this way, the use of TPUs according to the invention can contribute to the precise production of a hoof protector made of TP.

Furthermore, the TPs that can be used for the injection molding method must correspond to the requirements profile of a hoof protector from a process engineering perspective. Thus, for example, thermoplastic polypropylene (PP) has proven to be an advantageous base material in the production of a hoof protector using the injection molding method, but disadvantageous with regard to the criterion of slip resistance when used as a hoof protector on horses. Suitable for use as hoof protectors have proven to be thermoplastic polyurethanes (TPU). Polyester-based polyurethane materials are also used as technical parts for hoses, bellows, sieve elements and damping elements due to their many advantageous properties. In addition to the areas of TG that are advantageous for thermoplasticity and the coefficient of thermal expansion of TPU, the mechanical and chemical resistance and good shock absorption capacity of TPU have proven to be particularly advantageous for use as the base material of a hoof protector.

The hoof protector sole and the hoof protector lug system, as modules of the combination product of the inventive hoof protector made of thermoplastic polymer, are manufactured individually and joined together in the sense of the inventor. By means of thermoplastic master molding, in particular injection molding, a hoof protector of high material quality, in particular with regard to dimensional accuracy and dimensional stability, can be provided from a material of particularly advantageous properties with regard to the technical requirements of the hoof protector, which include the hardness of the hoof protector according to the invention.

### EXAMPLES

Further features and advantages of the present invention are apparent from the following drawings and examples of embodiments, by means of which the invention will be explained in more detail by way of example, without limiting the invention to these.

### Thereby Shows

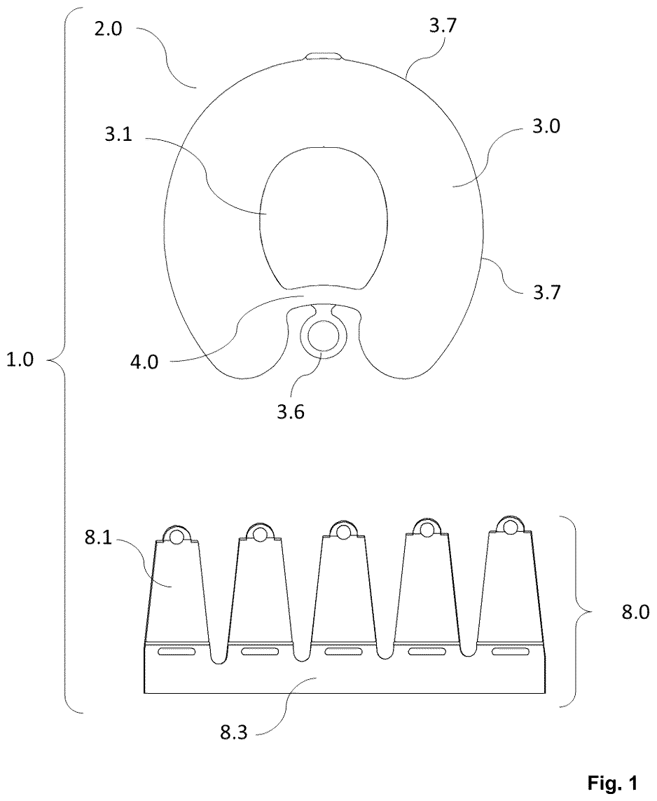

FIG. 1 a hoof protector, comprising a hoof shoe sole in a top view, here in the version as a base plate without a core, and a hoof protector lug system in a top view;

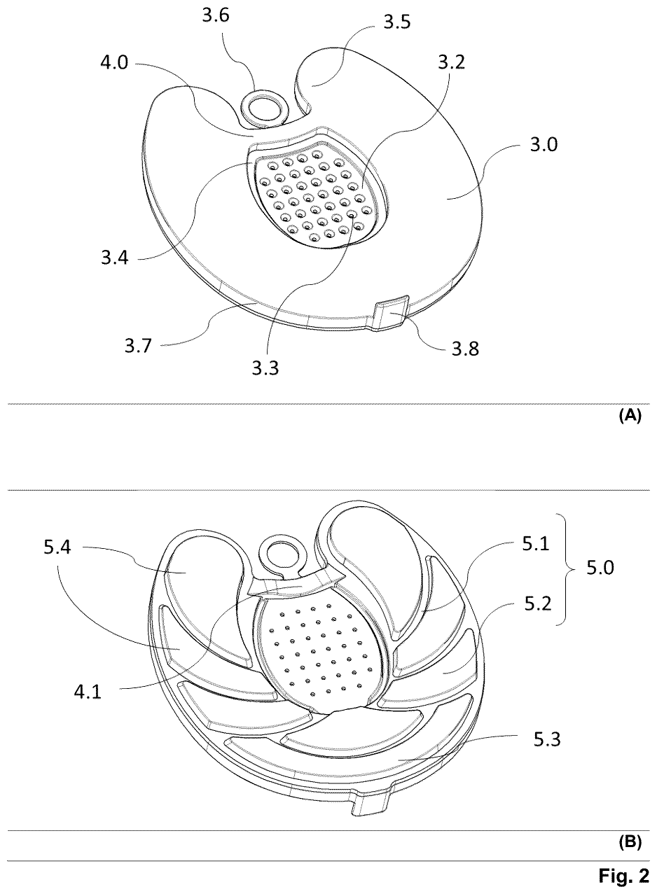

FIG. 2 a hoof protector sole in a perspective view of the base plate, wherein

FIG. 2A perspective view of the top side of the base plate and

FIG. 2B perspective view of the bottom side of the base plate;

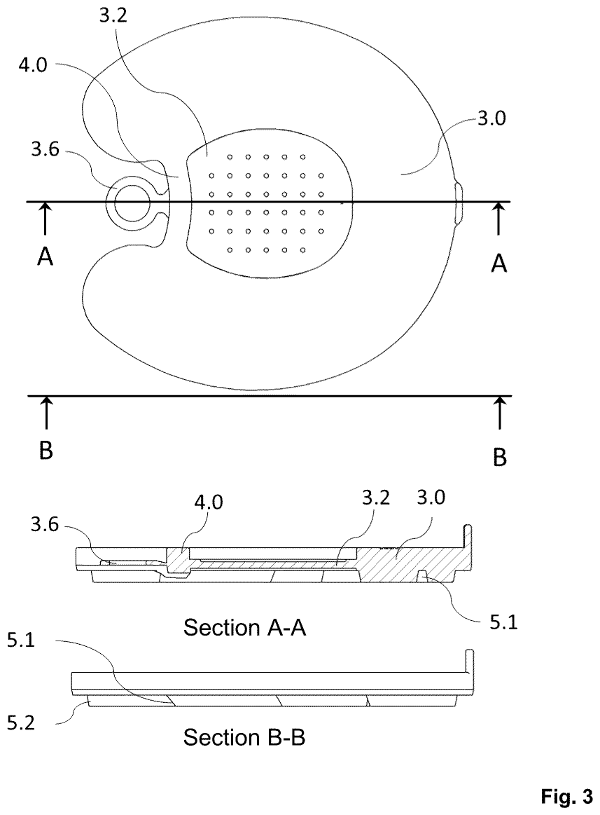

FIG. 3 a hoof protector sole in a schematic top view of the top side of the base plate, a vertical lateral sectional view (A-A) of the base plate and a side view (B-B) of the base plate;

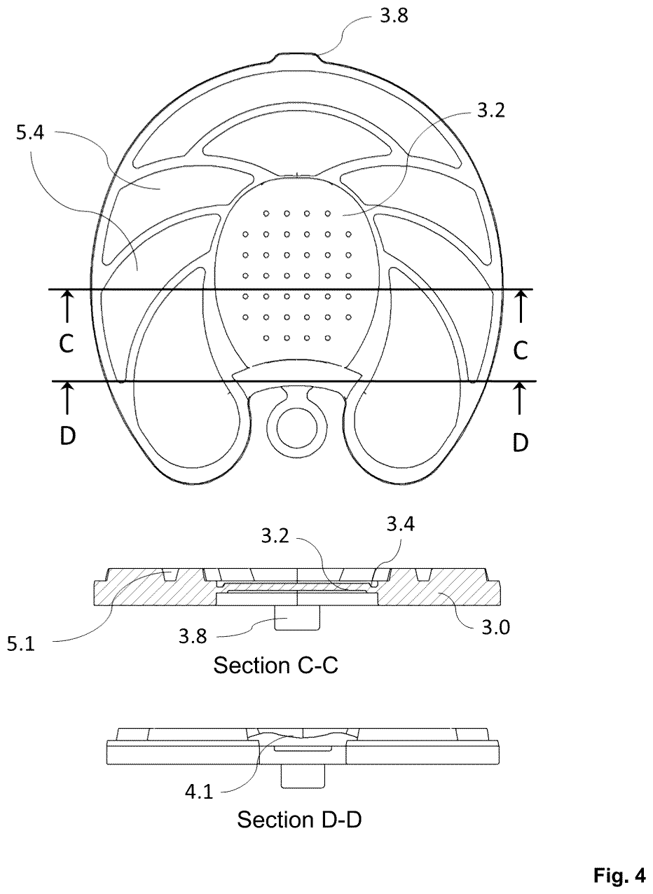

FIG. 4 a hoof protector sole in a schematic view of the bottom side of the base plate with the profile, a vertical sectional view (C-C) of the base plate and a vertical sectional view (D-D) of the base plate;

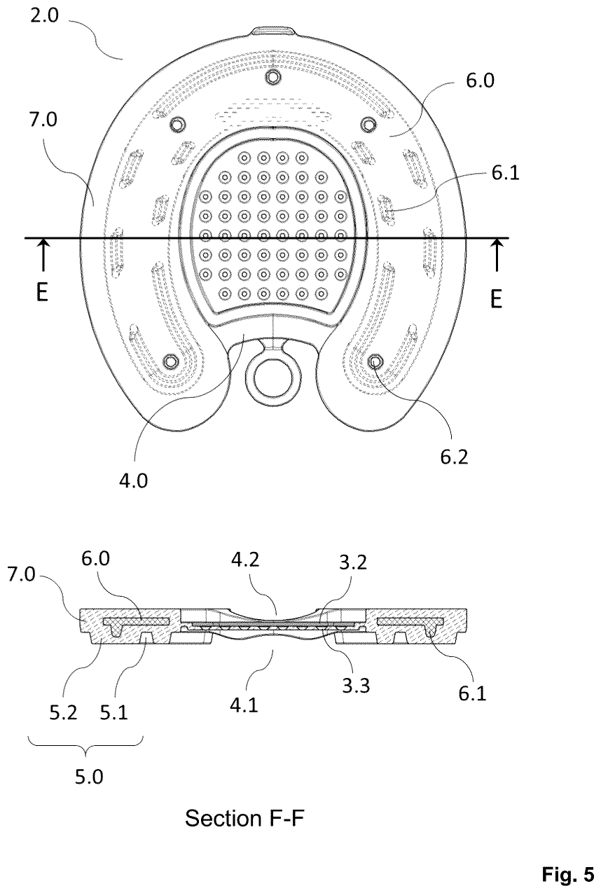

FIG. 5 a mantle with integrated core of a hoof protector sole in a top view of the base plate, wherein the integrated core is visible, and a vertical sectional view from the rear side of the base plate in plane E-E;

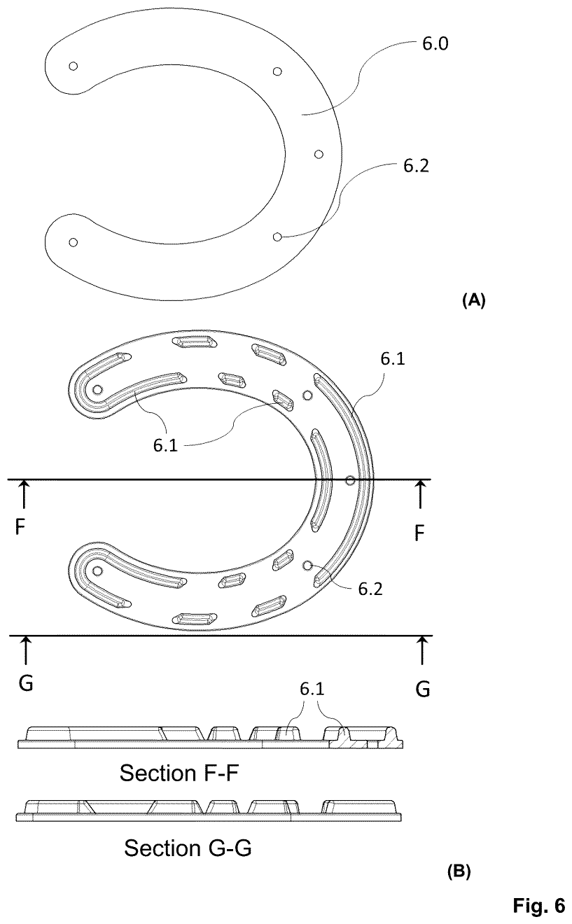

FIG. 6 a core of the hoof protector sole, wherein

FIG. 6A a core in a schematic top view of the top side of the core and

FIG. 6B a schematic top view of the bottom side of the core, a vertical sectional view (F-F) of the side of the core and a side view (G-G) of the side of the core;

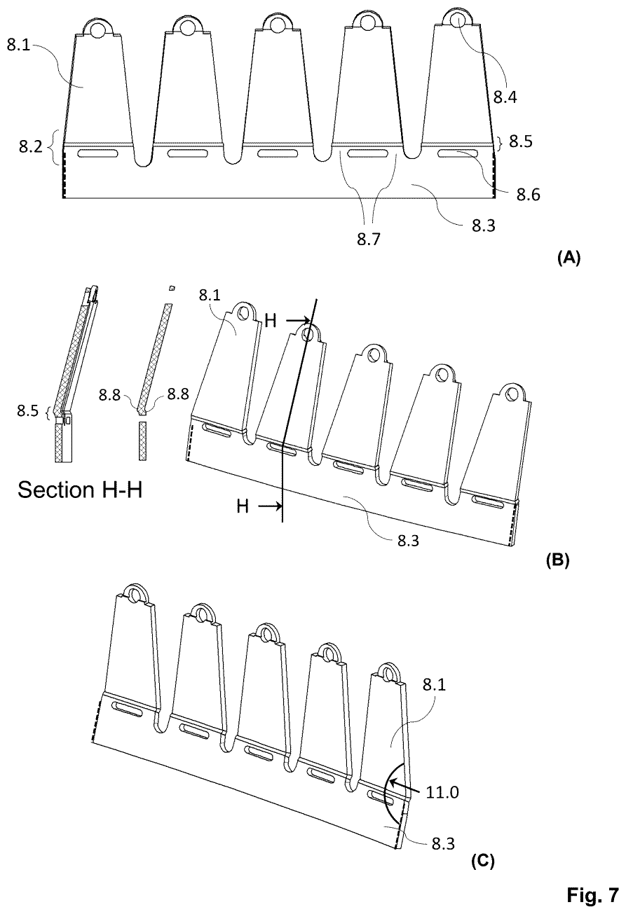

FIG. 7 a section of a hoof protector lug system,

FIG. 7A a top view and

FIG. 7B a perspective view of the outer sides of the hoof protector lug system facing away from the hoof and a section H-H as a perspective view and a sectional view through the axis of symmetry of a lug

FIG. 7C a hoof protector lug system as a perspective top view of its inner side with the inner angle;

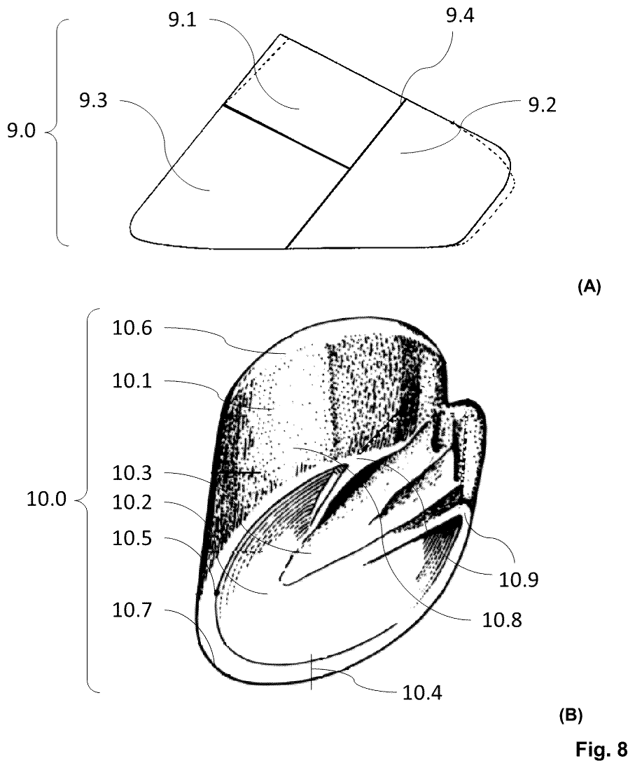

FIG. 8 a hoof of an equid and/or a horse, wherein

FIG. 8A a side view of a horse's hoof with the areas relevant to the hoof mechanism and

FIG. 8B a perspective lower side view of a horse's hoof.

The embodiment according to FIG. 1 shows an embodiment of the hoof protector (1.0) according to the invention comprising a hoof protector sole (2.0) and a hoof protector lug system (8.0), which is fixed to the outer wall (3.7) of the base plate (3.0) via the collar (8.3), wherein the lugs (8.1) are fixed to the lateral hoof wall. In one embodiment, a receiving eyelet (3.6) is arranged in the center of gravity horizontally to the base plate (3.0), for example on the bridge (4.0). A material-free recess (3.1) is arranged within the hoof protector sole (2.0).

An embodiment according to FIG. 2 shows perspective views of the hoof protector sole (2.0) comprising a base plate (3.0) and a profiling (5.4). The embodiment shown in FIG. 2A shows a perspective view of the top side of the base plate (3.0), which rests on the bottom side of the hoof when it is attached according to the invention. In the embodiment shown, the recess (3.1) is designed as a perforation plate (3.2) with perforations (3.3). A circumferential framing (3.4) on the edge of the perforation plate (3.2) has a lower material wall thickness than that of the perforation plate (3.2) and allows the user to easily remove the perforation plate (3.2) mechanically. A bridge (4.0) connecting the thighs (3.5) of the back of the base plate favors the stability of the base plate (3.0). A preferably orthogonal extension (3.8) to the orientation of the base plate (3.0), attached to the side of the base plate facing the hoof and projecting from the outer wall (3.7) of the hoof protector sole, promotes the adhesion of the hoof protector sole (2.0) when it is attached to the hoof of a horse in accordance with the invention.

The embodiment according to FIG. 2B shows a perspective view of the bottom side of the base plate (3.0) of a hoof protector sole The arch-shaped material recess (4.1) on the bottom side of the bridge (4.0) advantageously promotes in flexibility of the hoof protector sole and its shape the stability of the bridge. In a preferred embodiment, the bottom side of the base plate of the hoof protector sole has a profiling (5.0), which is characterized by recesses (5.1) and/or elevations (5.2) of the base plate and counteracts slipping of the hoof protector on the ground tread surface. The area of the profiling (5.0), which is located at the level of the front of the hoof when arranged as intended, has an arch-shaped elevation (5.3), while the profiling (5.0) in the area of the thighs (3.5) has elevations of a wing-shaped pattern (5.4). This type of profiling of the bottom side of the base plate according to the invention makes it possible for the thighs (3.5) of the base plate to move elastically and independently of one another.

The embodiment of the hoof protector sole shown in FIG. 3 shows a schematic top view of the top side of the base plate (3.0), wherein a vertical sectional view (A-A) shows a particularly preferred arrangement of the perforation plate (3.2) and the receiving eyelet (3.6) at the middle height of the base plate (3.0). The purpose of this arrangement is to ensure that the perforation plate (3.2) is neither in contact with the hoof nor with the ground. The embodiment shown in FIG. 3 also shows a preferred arrangement of the bridge (4.0) in the rear third of the base plate (3.0) as well as the preferred depth of the recesses (5.1) compared to the thickness of the base plate (3.0).

The embodiment shown in FIG. 4 has a wing-shaped pattern (5.4) of profiling (5.0). The circumferential framing (3.4) has a significantly lower thickness in relation to the material thickness of the base plate, which means that the perforation plate (3.2) can be easily cut off with a knife, for example. The arch-shaped material recess (4.1), which is arranged below the bridge (4.0), supports the flexibility of the hoof protector and saves material.

FIG. 5 shows an embodiment of the hoof protector sole (2.0) according to the invention, wherein the base plate (3.0) comprises at least one core (6.0) and a mantle (7.0) surrounding the core (6.0). The profiling of the core (6.1) and its shape in the structure of the base plate (3.0) is shown in the cross-sectional view (E-E). The cross-sectional view (E-E) shows conically shaped perforations (3.3) that taper in the direction opposite to the underside of the hoof, so that the probability of penetration and trapping of foreign bodies is reduced. An arch-shaped material recess (4.1) on the bottom side of the bridge (4.0) and a wedge-shaped material recess (4.2) on the top side of the bridge (4.0) promote the flexibility and stability of the hoof protector sole. The core (6.0) has core elevations (6.1) and core indentations (6.2), which are designed as holes. The combination of core elevations (6.1) and core indentations (6.2) means that the core (6.0) is connected to the surrounding mantle (7.0) in a more stable manner.

The embodiment of a core (6.0) shown in FIG. 6 shows the core (6.0) as a module of a version of the base plate (3.0), provided that this is formed at least from a core (6.0) and a mantle (7.0) enclosing the core. The core (6.0) is shown in FIG. 6A in a schematic top view of the top side of the core, wherein circular core indentations (6.2) are visible, which can be advantageously filled by the melt of the surrounding mantle material during manufacture, so that the cohesion of core and mantle is improved. The schematic top view of the bottom side of the core shown in FIG. 6B highlights the design of the core elevations (6.1), wherein the vertical cross-sectional view (F-F) and a lateral top view (G-G) of the side of the core illustrates the depth of the core elevations (6.1) of the core (6.0) relative to the material thickness of the core.

The embodiment of a hoof protector lug system (8.0) shown in FIG. 7 shows this in top view (FIG. 7A) and as perspective view (FIG. 7B) on the side facing away from the hoof as well as the inside facing the hoof (FIG. 7C), wherein the figures only show a section of the hoof protector lug system (8.0), limited by the dashed line to the sides of the section. The choice of the number of lugs (8.1) is, however, freely selectable and, in the inventive sense, adaptable to the length of the outer wall (3.7) of the base plate (3.0). The hoof protector lug system (8.0) shown in top view in FIG. 7A comprises the lugs (8.1), which optionally terminate with suspension eyelets (8.4), the web area (8.2), which includes the fold area (8.5) and the lug recess (8.6), as well as the collar (8.3), which according to the invention serves to attach the hoof protector lug system to the outer wall (3.7) of the base plate over a large area. FIG. 7B A cross-sectional view (H-H) through the axis of symmetry of a lug (8.1), which intersects the suspension eyelet (8.4) and web area (8.2), illustrates the inclination of the lug (8.1) relative to the collar (8.3) made possible by the fold area (8.5). The web area (8.2), which connects the collar and the lug in this design, comprises a lug recess (8.6) and (n+1) webs (8.7). In this embodiment, the lug recesses (8.6) are designed as a superellipse. The (n+1) webs (8.7) are particularly advantageous for the elastic stability of the hoof protector lug system (8.0).

In an alternative embodiment, the lugs (8.1) can be formed from more than one layer. By choosing polymer layers of different flexibility or hardness, a hardness gradient of the hoof protector lug system from the outer layer of the lug facing away from the hoof to the inner wall of the lug facing the hoof can be advantageously achieved, which is beneficial for the mechanical decoupling between a lug and the collar. FIG. 7C highlights the inner angle (11.0) achieved by the fold area (8.5) between the lug (8.1) and the collar (8.3) in a perspective view of the hoof-facing inner side of the hoof protector lug system, which enables the lug (8.1) of the hoof protector lug system (8.0) to be optimally attached to the lateral surface of the hoof wall.

The in FIG. 8A shows the areas of a hoof (9.0) of an equid and/or a horse which can be assigned corresponding to the hoof mechanism, the elastic deformation of the horn capsule during loading and unloading, and which are of great relevance for the shape of the hoof protector. Some parts of the hoof are compressed (9.1) and others are stretched (9.2), which ensures optimal shock absorption of the physical forces during gait corresponding to the gait mechanics. More static is the area (9.3) of the hoof, whereas the widest part of the hoof (9.4) is maximally elastically extended to the right and left. In FIG. 8B a perspective lower side view of a horse's hoof is shown. More precisely, FIG. 8B shows a hoof capsule (10.0) of an equid and/or a horse, which comprises a hoof wall (10.1) laterally enclosing the hoof, a hard hoof sole (10.2) and a hoof ray (10.3) denoting the soft part of the hoof sole. The ground-side edge of the hoof wall (10.1), the so-called bearing edge (10.4) and the hoof sole are separated by a white horn line (10.5). The horn line can indicate to the farrier where he can hammer in the nails required to attach the horseshoe without damaging the sensitive corium. The upper edge of the hoof capsule is terminated by a horn crown (10.6), which merges into the normal hairy skin of the equine and/or horse. The hoof wall (10.1) is divided into three areas from front to back, wherein the front area is referred to as the toe (10.7), the middle area on the right and left as the hoof sidewall (10.8) and the rear area as the heels (10.9).

### LIST OF REFERENCE NUMERALS

(1.0) Hoof protector
(2.0) Hoof protector sole
(3.0) Base plate
(3.1) Recess
(3.2) Perforation plate
(3.3) Perforation
(3.4) Circumferential framing
(3.5) Thigh
(3.6) Receiving eyelet
(3.7) Outer wall
(3.8) Extension
(4.0) Bridge
(4.1) Arch-shaped material recess
(4.2) Wedge-shaped material recess
(5.0) Profiling
(5.1) Recess
(5.2) Elevation
(5.3) Arch-shaped elevation
(5.4) wing-shaped pattern
(6.0) Core
(6.1) Core elevation
(6.2) Core indentation
(7.0) Mantle
(8.0) Hoof protector lug system
(8.1) Lug
(8.2) Web area
(8.3) Collar
(8.4) Receiving eyelet
(8.5) Fold area
(8.6) Lug recess/recess
(8.7) Web
(8.8) Fold
(9.0) Area of the hoof of an equine relevant to the hoof mechanism
(9.1) compressed area of the hoof relevant to hoof mechanism
(9.2) stretched area of the hoof during hoof mechanism
(9.3) static area of the hoof at the hoof mechanism
(9.4) widest part of the hoof at the hoof mechanism
(10.0) Hoof capsule/hoof
(10.1) Hoof wall
(10.2) Hoof sole
(10.3) Hoof ray
(10.4) Bearing edge
(10.5) White horn line
(10.6) Horn crown
(10.7) Toe
(10.8) Hoof sidewall
(10.9) Heels
(11.0) Inner angle

1. A method of attaching a hoof protector (1.0) to a hoof (10.0) of an equine animal, characterized by
(i) Partial melting, by means of a temporary heat input, of at least one hoof side oriented
layer of at least one lug (8.1) of a hoof protector lug system (8.0), that is made of a thermoplastic polymer, wherein the hoof protector lug system (8.0) is formed from a collar (8.3) and at least one lug (8.1), wherein the collar (8.3) and each of the at least one lug (8.1) are connected to each other via a web area (8.2), wherein the web area (8.2) connects the at least one lug (8.1) with the collar (8.3) via webs (8.7), the web area (8.2) comprises at least one recess (8.6) which is in the form of an ellipse or a superellipse, two webs (8.7) are formed on opposite sides of each recess (8.6), and a number of the webs (8.7) is twice a number of the at least one recess (8.6),
(ii) Bringing into contact the partially melted hoof side oriented layer of the lug (8.1) from step (i) with a hoof wall (10.1),
(iii) Thermal welding of the partially melted hoof side oriented layer of the lug (8.1) from step (ii) to the hoof wall (10.1) wherein the thermal welding comprises cooling and a material bonding connecting the hoof side oriented layer of the lug (8.1) to the hoof wall (10.1).

2. The method of claim 1, wherein the hoof protector lug system (8.0) comprises at least one fold (8.8) arranged between the collar (8.3) and the lug (8.1).

3. The method of claim 1, wherein the hoof protector lug system (8.0) comprises a fold area (8.5), wherein the fold area (8.5) is formed of two successive folds (8.8).

4. The method of claim 1, wherein the lug (8.1) and/or the collar (8.3) is constructed of at least two-layers, wherein one of the layers is oriented on the hoof side and one of the layers is oriented away from the hoof and wherein at least one of the layers is formed from the thermoplastic polymer.
